(19) United States
(12) Patent Application Publication
(10) Pub. No.: US 2026/0342453 A1
(43) Pub. Date: Oct. 29, 2026

(54) METHOD AND APPARATUS FOR CANCELLATION IN WIRELESS COMMUNICATION SYSTEM

(71) Applicant: Samsung Electronics Co., Ltd., Suwon-si, Gyeonggi-do (KR)

(72) Inventors: Nan QU, Beijing (CN); Chen QIAN, Beijing (CN); Di SU, Beijing (CN); Peng LIN, Beijing (CN); Zhongfeng ZHANG, Beijing (CN)

(21) Appl. No.: 19/485,428

(22) PCT Filed: May 24, 2024
(86) PCT No.: PCT/KR2024/007079

§ 371 Date: Nov. 18, 2025

(30) Foreign Application Priority Data
May 25, 2023 (CN) 202310605048.4

(51) Int. Cl. H04B 15/02

(52) U.S. Cl. CPC H04B 15/02

(57) ABSTRACT

The disclosure relates to a 5G or 6G communication system for supporting a higher data transmission rate. A method performed by a device in a wireless communication system is provided. The method comprises identifying a first signal and a second signal, wherein the first signal is associated with a sum beam signal and the second signal is associated with a differential beam signal and performing first self-interference cancellation on the first signal based on a first parameter set to obtain a first residual signal associated with a sensing.

### TECHNICAL FIELD

Embodiments of the present disclosure relate to the field of wireless communication, and more particularly, to a node in a wireless communication system and a method performed thereof.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Solution to Problem

A method performed by a device in a wireless communication system is provided. The method comprises identifying a first signal and a second signal, wherein the first signal is associated with a sum beam signal and the second signal is associated with a differential beam signal and performing first self-interference cancellation on the first signal based on a first parameter set to obtain a first residual signal associated with a sensing.

A device in a wireless communication system is provided. The device comprises a transceiver and a controller coupled with the transceiver and configured to identify a first signal and a second signal, wherein the first signal is associated with a sum beam signal and the second signal is associated with a differential beam signal, and perform first self-interference cancellation on the first signal based on a first parameter set to obtain a first residual signal associated with a sensing.

### BRIEF DESCRIPTION OF DRAWINGS

In order to illustrate the technical scheme of the embodiments of the present disclosure more clearly, the accompanying drawings of the embodiments will be briefly introduced below. Obviously, the accompanying drawings in the following description only relate to some of the embodiments of the present disclosure, and are not limited to the present disclosure.

The accompanying drawings herein, which are incorporated in and constitute a part of the specification, illustrate exemplary embodiments consistent with the present disclosure, and together with the description, serve to explain the principles of the present disclosure, and do not unduly limit the present disclosure.

FIG. 1 is a diagram illustrating an example wireless network 100 according to various embodiments of the present disclosure;

FIG. 2A illustrates example wireless transmission and reception paths according to the present disclosure

FIG. 2B illustrates example wireless transmission and reception paths according to the present disclosure;

FIG. 3A illustrates an example UE 116 according to the present disclosure;

FIG. 3B illustrates an example gNB 102 according to the present disclosure;

FIG. 4A illustrates a diagram illustrating methods performed by a wireless communication device according to the present disclosure;

FIG. 4B illustrates a diagram illustrating methods performed by a wireless communication device according to the present disclosure;

FIG. 4C illustrates a diagram illustrating methods performed by a wireless communication device according to the present disclosure;

FIG. 5 is a block diagram illustrating a wireless communication device according to the present disclosure;

FIG. 6 is a flowchart illustrating a method performed by a wireless communication device according to an embodiment of the present disclosure;

FIG. 7 illustrates beam patterns of a sum beam and a differential beam according to an embodiment of the present disclosure;

FIG. 8 is a flowchart illustrating another method performed by a wireless communication device according to an embodiment of the present disclosure;

FIG. 9 is a flowchart illustrating a method for target detection and angle estimation performed by a wireless communication device according to an embodiment of the present disclosure;

FIG. 10 is a flowchart illustrating a method for target detection and angle estimation performed by a wireless communication device according to an embodiment of the present disclosure;

FIG. 11 is a flowchart illustrating a method for target detection and angle estimation performed by a wireless communication device according to an embodiment of the present disclosure;

FIG. 12 is a flowchart illustrating a method for target detection and angle estimation performed by a wireless communication device according to an embodiment of the present disclosure;

FIG. 13 is a schematic diagram illustrating a result of target detection in a case that a self-interference cancellation according to an embodiment of the present disclosure is not performed;

FIG. 14 is a schematic diagram illustrating a result of target detection in the case that a self-interference cancellation according to an embodiment of the present disclosure is performed;

FIG. 15 illustrates processes of self-interference cancellation according to various embodiments of the present disclosure;

FIG. 16 illustrates processes of self-interference cancellation according to various embodiments of the present disclosure;

FIG. 17 illustrates processes of self-interference cancellation according to various embodiments of the present disclosure;

FIG. 18A illustrates sampling situations in ideal and actual sensing environments;

FIG. 18B illustrates sampling situations in ideal and actual sensing environments;

FIG. 19 illustrates additional processes of self-interference cancellation according to various embodiments of the present disclosure;

FIG. 20A illustrates illustrates additional processes of self-interference cancellation according to various embodiments of the present disclosure;

FIG. 20B illustrates a relationship between channel paths and delay;

FIG. 21 additional processes of self-interference cancellation according to various embodiments of the present disclosure;

FIG. 22 illustrates additional processes of self-interference cancellation according to various embodiments of the present disclosure;

FIG. 23 illustrates a structure of a UE according to an embodiment of the disclosure; and

FIG. 24 illustrates a structure of a base station according to an embodiment of the disclosure.

### BEST MODE FOR CARRYING OUT THE INVENTION

The following description with reference to the accompanying drawings is provided to facilitate a comprehensive understanding of various embodiments of the present disclosure as defined by the claims and their equivalents. This description comprises various specific details to facilitate understanding but should be regarded as exemplary only. Accordingly, those of ordinary skill in the art will recognize that various changes and modifications of the various embodiments described herein can be made without departing from the scope and spirit of the present disclosure. Also, descriptions of well-known functions and constructions may be omitted for clarity and conciseness.

The terms and phraseology used in the following specification and claims are not limited to their dictionary meanings, but, are merely used by the inventor to enable a clear and consistent understanding of the present disclosure. Accordingly, it should be apparent to those skilled in the art that the following description of various embodiments of the present disclosure is provided for illustration purposes only and not for the purpose of limiting the scope of the present disclosure as defined by the appended claims and their equivalents.

It should be understood that the singular forms “a”, “an” and “the” comprise plural referents unless the context clearly dictates otherwise. Thus, for example, reference to “a component surface” comprises reference to one or more of such surfaces.

The terms “comprise” or “may comprise” refer to presence of a correspondingly disclosed function, operation, or component that may be used in various embodiments of the present disclosure, rather than excluding presence of one or more additional functions, operations, or features. Furthermore, the terms “comprise” or “have” may be interpreted to mean certain characteristics, numbers, steps, operations, constituent elements, components, or combinations thereof, but should not be interpreted as excluding one or more other characteristics, numbers, steps, operations, constituent elements, components, or the possibility of existence of a combination thereof.

The term “or” as used in various embodiments of the present disclosure comprises any of the listed terms and all combinations thereof. For example, “A or B” may comprise A, may comprise B, or may comprise both A and B.

Unless defined differently, all terms (including technical or scientific terms) used in the present disclosure have the same meaning as understood by one of ordinary skill in the art described in the present disclosure. Common terms as defined in dictionaries are to be interpreted to have meanings consistent with the context in the relevant technical field, and should not be interpreted ideally or overly formalized unless explicitly so defined in the present disclosure.

When describing the embodiments of the present disclosure, descriptions related to the technical contents well-known in the art and not directly associated with the present disclosure may be omitted. Such omission of unnecessary description is intended to avoid obscuring the main idea of the present disclosure.

Advantages and features of the present disclosure as well as implementations thereof will be apparent by referring to the following embodiments in detail in conjunction with the accompanying drawings. However, the present disclosure is not limited to the embodiments set forth below, but can be implemented in various forms. The following examples are provided only to fully disclose the present disclosure and to inform those skilled in the art of its scope, and the present disclosure is defined only by the scope of the appended claims. Throughout this specification, like or similar reference numerals indicate like or similar elements.

Herein, it should be understood that each block in the flowchart illustration and combinations of blocks in the flowchart illustration may be implemented by computer program instructions. These computer program instructions may be provided to a processor of a general-purpose computer, special-purpose computer or other programmable data processing apparatus to produce a machine, such that the instructions executed via the processor of the computer or other programmable data processing apparatus create means for implementing functions specified in a flowchart block or blocks. These computer program instructions may also be stored in a computer-usable or computer-readable memory, which may instruct a computer or other programmable data processing apparatus to function in a particular manner, such that the instructions stored in the computer-usable or computer-readable memory produce an article of manufacture including instruction means for implementing functions specified in a flowchart block or blocks. The computer program instructions may also be loaded onto a computer or other programmable data processing apparatus to cause a series of operations to be performed on the computer or other programmable apparatus to produce a computer-implemented process, such that the instructions executed on the computer or other programmable apparatus provide operations for implementing functions specified in a flowchart block or blocks.

Moreover, each block of the flowchart may represent a module, segment or part of code, which includes one or more executable instructions for implementing specified logical function(s). It should also be noted that in some alternatives, the functions shown in the blocks may occur out of order. For example, according to the functions involved, two blocks shown in succession may actually be executed at substantially the same time, or may be executed in the reverse order.

Various embodiments of the present disclosure may be implemented as computer-readable codes specifically embodied on a computer-readable recording medium from a specific perspective. The computer-readable recording medium may be a volatile computer-readable recording medium or a nonvolatile computer-readable recording medium. A computer-readable recording medium is any data storage device that can store data readable by a computer system. Examples of computer-readable recording media may include read-only memory (ROM), random access memory (RAM), compact disk read-only memory (CD-ROM), magnetic tape, floppy disk, optical data storage device, carrier wave (e.g., data transmission via the Internet), and the like. Computer-readable recording media can be distributed through computer systems connected via a network, and thus computer-readable codes can be stored and executed in a distributed manner. Moreover, functional programs, codes and code segments for implementing various embodiments of the present disclosure can be easily interpreted by those skilled in the art to which the embodiments of the present disclosure are applied.

It will be understood that the embodiments of the present disclosure can be implemented in the form of hardware, software, or a combination of hardware and software. Software may be stored as program instructions or computer-readable code executable on a processor on a non-transitory computer-readable medium. Examples of non-transitory computer-readable recording media include magnetic storage media (e.g., ROM, floppy disk, hard disk, etc.) and optical recording media (e.g., CD-ROM, digital video disk (DVD), etc.). Non-transitory computer-readable recording media may also be distributed across network-coupled computer systems, so that computer-readable codes are stored and executed in a distributed manner. The medium can be read by a computer, stored in a memory, and executed by a processor. Various embodiments may be implemented by a computer or a portable terminal including a controller and a memory, and the memory may be an example of a non-transitory computer-readable recording medium suitable for storing program(s) having instructions for implementing the embodiments of the present disclosure. The present disclosure may be implemented by a program having codes for specifically implementing the apparatus and method described in the claims, which is stored in a machine (or computer) readable storage medium. The program may be electronically carried on any medium, such as a communication signal transferred via a wired or wireless connection, and the present disclosure appropriately includes its equivalents.

The solutions of the embodiments of the present application may be applied to, for example, the communication systems may comprise a Global System for Mobile communications (GSM) system, a code division multiple access (CDMA) system, a broadband Code Division Multiple Access (WCDMA) system, General Packet Radio Service (GPRS), Long Term Evolution (LTE) system, LTE Frequency Division Duplex (FDD) system, LTE Time Division Duplex (TDD), universal mobile telecommunication system (UMTS), worldwide interoperability for microwave access (WiMAX) communication system, fifth generation (5th generation, 5G) system or new radio (NR), etc. In addition, the solutions of the embodiments of the present application may be applied to future-oriented communication technologies.

Considering the development of wireless communication from generation to generation, the technologies have been developed mainly for services targeting humans, such as voice calls, multimedia services, and data services. Following the commercialization of 5th-generation (5G) communication systems, it is expected that the number of connected devices will exponentially grow. Increasingly, these will be connected to communication networks. Examples of connected things may include vehicles, robots, drones, home appliances, displays, smart sensors connected to various infrastructures, construction machines, and factory equipment. Mobile devices are expected to evolve in various form-factors, such as augmented reality glasses, virtual reality headsets, and hologram devices. In order to provide various services by connecting hundreds of billions of devices and things in the 6th-generation (6G) era, there have been ongoing efforts to develop improved 6G communication systems. For these reasons, 6G communication systems are referred to as beyond-5G systems.

6G communication systems, which are expected to be commercialized around 2030, will have a peak data rate of tera (1,000 giga)-level bps and a radio latency less than 100 μsec, and thus will be 50 times as fast as 5G communication systems and have the 1/10 radio latency thereof.

In order to accomplish such a high data rate and an ultra-low latency, it has been considered to implement 6G communication systems in a terahertz band (e.g., 95 GHz to 3 THz bands). It is expected that, due to severer path loss and atmospheric absorption in the terahertz bands than those in mmWave bands introduced in 5G, technologies capable of securing the signal transmission distance (i.e., coverage) will become more crucial. It is necessary to develop, as major technologies for securing the coverage, radio frequency (RF) elements, antennas, novel waveforms having a better coverage than orthogonal frequency division multiplexing (OFDM), beamforming and massive multiple input multiple output (MIMO), full dimensional MIMO (FD-MIMO), array antennas, and multiantenna transmission technologies such as large-scale antennas. In addition, there has been ongoing discussion on new technologies for improving the coverage of terahertz-band signals, such as metamaterial-based lenses and antennas, orbital angular momentum (OAM), and reconfigurable intelligent surface (RIS).

Moreover, in order to improve the spectral efficiency and the overall network performances, the following technologies have been developed for 6G communication systems: a full-duplex technology for enabling an uplink transmission and a downlink transmission to simultaneously use the same frequency resource at the same time; a network technology for utilizing satellites, high-altitude platform stations (HAPS), and the like in an integrated manner; an improved network structure for supporting mobile base stations and the like and enabling network operation optimization and automation and the like; a dynamic spectrum sharing technology via collision avoidance based on a prediction of spectrum usage; an use of artificial intelligence (AI) in wireless communication for improvement of overall network operation by utilizing AI from a designing phase for developing 6G and internalizing end-to-end AI support functions; and a next-generation distributed computing technology for overcoming the limit of user equipment (UE) computing ability through reachable super-high-performance communication and computing resources (such as mobile edge computing (MEC), clouds, and the like) over the network. In addition, through designing new protocols to be used in 6G communication systems, developing mechanisms for implementing a hardware-based security environment and safe use of data, and developing technologies for maintaining privacy, attempts to strengthen the connectivity between devices, optimize the network, promote softwarization of network entities, and increase the openness of wireless communications are continuing.

It is expected that research and development of 6G communication systems in hyper-connectivity, including person to machine (P2M) as well as machine to machine (M2M), will allow the next hyper-connected experience. Particularly, it is expected that services such as truly immersive extended reality (XR), high-fidelity mobile hologram, and digital replica could be provided through 6G communication systems. In addition, services such as remote surgery for security and reliability enhancement, industrial automation, and emergency response will be provided through the 6G communication system such that the technologies could be applied in various fields such as industry, medical care, automobiles, and home appliances.

According to an aspect of the present disclosure, there is provided a method performed by a node in a wireless communication system, comprising: obtaining a first signal and a second signal, wherein the first signal is a sum beam signal and the second signal is a differential beam signal; performing first self-interference cancellation on the first signal based on a first parameter set to obtain a first residual signal; determining a second parameter set, and performing second self-interference cancellation on the second signal based on the second parameter set to obtain a second residual signal; and performing target sensing through the first residual signal and the second residual signal; wherein the second parameter set is determined based on at least one of the first parameter set, the first signal and the second signal.

According to one or more embodiments of the present disclosure, the second parameter set includes an order of the second self-interference cancellation and/or channel paths of the second self-interference cancellation.

According to one or more embodiments of the present disclosure, determining the second parameter set comprises at least one of: determining the order of the second self-interference cancellation based on an order of the first self-interference cancellation in the first parameter set; determining a first order based on a result of comparison between a power value of each order component of a first reconstructed signal and a power value of the second signal, and determining the order of the second self-interference cancellation based on the first order; determining a first order based on a result of comparison between a power value of each order component of a first reconstructed signal and a power value of the second signal, and determining the order of the second self-interference cancellation based on the first order and an order of the first self-interference cancellation in the first parameter set; wherein the first reconstructed signal is a signal cancelled when the first self-interference cancellation is performed on the first signal.

According to an embodiment of the present disclosure, determining the first order based on a result of comparison between a power value of each order component of a first reconstructed signal and a power value of the second signal comprises: determining the first order as 0 in the case that the power value of each order component of the first reconstructed signal is greater than or equal to the power value of the second signal; and determining the first order as the minimum value of the orders of at least first-order components of the first reconstructed signal in the case that the power value of the at least first-order components of the first reconstructed signal is smaller than the power value of the second signal.

According to one or more embodiments of the present disclosure, determining the second parameter set comprises determining the channel paths of the second self-interference cancellation based on the channel paths of the first self-interference cancellation in the first parameter set; obtaining a first power spectrum corresponding to the first signal and a second power spectrum corresponding to the second signal, and determining a second channel path(s) based on the first power spectrum and the second power spectrum, and determining the channel paths of the second self-interference cancellation based on the second channel path(s); obtaining a first power spectrum corresponding to the first signal and a second power spectrum corresponding to the second signal, determining a second channel path(s) based on the first power spectrum and the second power spectrum, and determining channel paths of the second self-interference cancellation based on the channel paths of the first self-interference cancellation and the second channel path(s) in the first parameter set; wherein the first power spectrum represents a correspondence between distances and powers of a result of channel estimation of the first signal, and the second power spectrum represents a correspondence between distances and powers of a result of channel estimation of the second signal, or the first power spectrum represents a correspondence between both distances and velocities and powers of a result of channel estimation of the first signal, and the second power spectrum represents a correspondence between both distances and velocities and powers of a result of channel estimation of the second signal.

According to one or more embodiments of the present disclosure, determining the first channel path(s) based on the first power spectrum and the second power spectrum comprises: determining the first channel path(s) based on a first distance corresponding to a first sample in the second power spectrum that meets a first condition, and wherein the first condition is that a difference between a power value corresponding to the first sample in the second power spectrum and a noise floor power value in the second power spectrum is greater than or equal to a difference between the maximum power value in the first power spectrum and a noise floor power value in the first power spectrum.

According to one or more embodiments of the present disclosure, the power spectrum includes at least one of a distance spectrum and a distance-velocity spectrum.

According to an embodiment of the present disclosure, a sum beam signal and a differential beam signal are obtained based on a first sensing signal and a second sensing signal; wherein the second sensing signal is a signal resulting from transforming the first sensing signal into time domain by adding linear phase rotation to the first sensing signal in frequency domain.

According to one embodiment of the present disclosure, the first sensing signal and the second sensing signal are discrete signals resulting from sampling a same analog signal at the same sampling starting time or different sampling starting times.

According to another aspect of the present disclosure, there is provided a method performed by a node in a wireless communication system, comprising: obtaining a third signal; performing channel estimation on the third signal to obtain a power spectrum; determining parameters for self-interference cancellation based on the power spectrum; and performing self-interference cancellation using the determined parameters for self-interference cancellation.

According to one or more embodiments of the present disclosure, the parameters include at least one of indexes of channel paths of self-interference cancellation, an index set of channel paths of self-interference cancellation, an order of self-interference cancellation, and an order corresponding to a channel path of self-interference cancellation.

According to an embodiment of the present disclosure, determining parameters for self-interference cancellation based on the power spectrum comprises determining channel paths corresponding to samples in the power spectrum that are above a predetermined threshold as the parameters for self-interference cancellation.

According to an embodiment of the present disclosure, the method further comprises: determining parameters for self-interference cancellation based on the power spectrum comprises performing a detection algorithm based on the power spectrum so as to obtain a first index set of channel paths of self-interference cancellation; and determining a third index set of channel paths of self-interference cancellation based on the first index set of channel paths of self-interference cancellation and a predetermined or configured second index set of channel paths of self-interference cancellation.

According to an embodiment of the present disclosure, the third index set of channel paths of self-interference cancellation comprises a union of the first index set of channel paths of self-interference cancellation and the predetermined or configured second index set of channel paths of self-interference cancellation, or an intersection of the first index set of channel paths of self-interference cancellation and the predetermined or configured second index set of channel paths of self-interference cancellation.

According to an embodiment of the present disclosure, the power spectrum includes at least one of a distance spectrum and a distance-velocity spectrum.

According to an embodiment of the present disclosure, determining parameters for self-interference cancellation based on the power spectrum comprises comparing a power corresponding to each channel path in the power spectrum with a set threshold, and determining an order of self-interference cancellation corresponding to a respective channel path based on a result of comparison.

According to an embodiment of the present disclosure, a first order of self-interference cancellation is set for a channel path with a first power in the power spectrum; and a second order of self-interference cancellation higher than the first order of self-interference cancellation is set for a channel path with a second power higher than the first power in the power spectrum.

According to another aspect of the present disclosure, there is provided a method performed by wireless communication in a wireless communication system, comprising: transmitting a fourth signal; receiving a fifth signal, obtaining a local signal for self-interference cancellation corresponding to a non-sampling time based on the fourth signal; estimating a self-interference channel corresponding to an echo signal of the fourth signal based on the obtained local signal for self-interference cancellation; and performing self-interference cancellation on the fifth signal based on the self-interference channel.

According to an embodiment of the present disclosure, the local signal is obtained by: obtaining a frequency domain signal corresponding to the fourth signal; adding linear phase rotation to the frequency domain signal to obtain a frequency domain signal with linear phase rotation, wherein the linear phase rotation is related to one or more delays in which the sampling time is away from the non-sampling time; and transforming the frequency domain signal with linear phase rotation into a time domain signal to obtain the local signal.

According to an embodiment of the present disclosure, the delay is obtained based on a delay ratio parameter and a signal sampling rate.

According to an embodiment of the present disclosure, the delay ratio parameter is determined according to an index set of channel paths and the power spectrum.

According to an embodiment of the present disclosure, the local signal is calculated for each element in the index set of channel paths.

According to an embodiment of the present disclosure, calculating the local signal for each element in the index set of channel paths further comprises: calculating, for an element in the index set of channel paths, a local signal corresponding to the element, and obtaining local signals corresponding to other elements in the index set of channel paths by means of cyclic shift; or determining, for each element in the index set of channel paths, a delay respectively corresponding to the element, and obtaining, for each element in the index set of channel paths, a local signal corresponding to the element, based on the calculated delay.

According to an embodiment of the present disclosure, the index set of channel paths is obtained based on both of: a third index set of channel paths of self-interference cancellation obtained by performing a detection algorithm based on the power spectrum; and a predetermined or configured fourth index set of channel paths of self-interference cancellation.

According to an embodiment of the present disclosure, wherein the index set of channel paths of self-interference cancellation includes a union of the third index set of channel paths of self-interference cancellation and the predetermined or configured fourth index sets of the channel paths of self-interference cancellation, or an intersection of the third index set of channel paths of self-interference cancellation and the predetermined or configured fourth index set of channel paths of self-interference cancellation.

According to an embodiment of the present disclosure, the sampling time includes at least one of a sampling starting time and a latest sampling time before a non-sampling time.

According to an embodiment of the present disclosure, the power spectrum includes at least one of a distance spectrum and a distance-velocity spectrum.

According to an embodiment of the present disclosure, the fifth signal includes at least one of an echo signal corresponding to the fourth signal and an echo signal corresponding to a sixth signal different from the fourth signal.

According to an embodiment of the present disclosure, performing self-interference cancellation on the fifth signal is also based on a transmitted signal corresponding to the fifth signal, or the local signal for self-interference cancellation corresponding to the non-sampling time obtained according to a transmitted signal corresponding to the fifth signal.

According to an embodiment of the present disclosure, performing self-interference cancellation on the fifth signal further comprises: obtaining a self-interference reconstructed signal based on the fourth signal and a self-interference channel corresponding to an echo signal of the fourth signal; and performing self-interference cancellation on the fifth signal based on the self-interference reconstructed signal.

According to an embodiment of the present disclosure, performing self-interference cancellation on the fifth signal further comprises: obtaining a self-interference reconstructed signal based on a self-interference channel corresponding to an echo signal of the fourth signal and a transmitted signal corresponding to the fifth signal; and performing self-interference cancellation on the fifth signal based on the self-interference reconstructed signal.

According to an embodiment of the present disclosure, performing self-interference cancellation on the fifth signal further comprises: obtaining a self-interference reconstructed signal based on a self-interference channel corresponding to an echo signal of the fourth signal and the local signal for self-interference cancellation corresponding to the non-sampling time obtained according to a transmitted signal corresponding to the fifth signal; and performing self-interference cancellation on the fifth signal based on the self-interference reconstructed signal.

According to another aspect of the present disclosure, there is provided a node in a wireless communication system, comprising: a transceiver; and a processor configured to perform any of the methods described above.

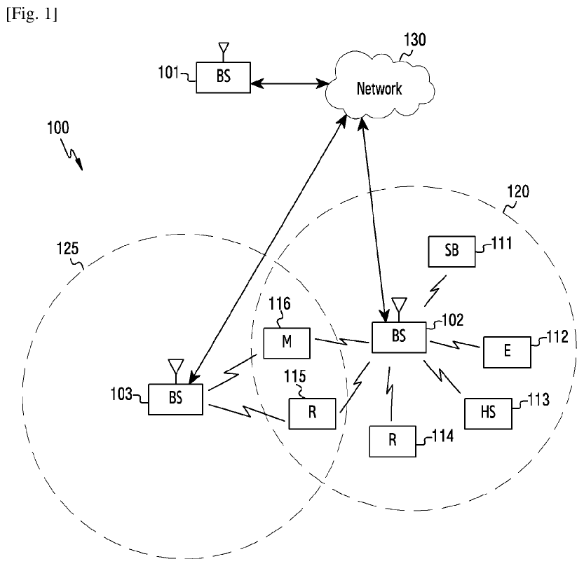

FIG. 1 illustrates an example wireless network 100 according to various embodiments of the present disclosure. The embodiment of the wireless network 100 shown in FIG. 1 is for illustration only. Other embodiments of the wireless network 100 can be used without departing from the scope of the present disclosure.

The wireless network 100 comprises a gNodeB (gNB) 101, a gNB 102, and a gNB 103. gNB 101 communicates with gNB 102 and gNB 103. gNB 101 also communicates with at least one Internet Protocol (IP) network 130, such as the Internet, a private IP network, or other data networks.

Depending on a type of the network, other well-known terms such as “base station” or “access point” can be used instead of “gNodeB” or “gNB”. For convenience, the terms “gNodeB” and “gNB” are used in this patent document to refer to network infrastructure components that provide wireless access for remote terminals. And, depending on the type of the network, other well-known terms such as “mobile station”, “user station”, “remote terminal”, “wireless terminal” or “user apparatus” can be used instead of “user equipment” or “UE”. For convenience, the terms “user equipment” and “UE” are used in this patent document to refer to remote wireless devices that wirelessly access the gNB, no matter whether the UE is a mobile device (such as a mobile phone or a smart phone) or a fixed device (such as a desktop computer or a vending machine).

gNB 102 provides wireless broadband access to the network 130 for a first plurality of User Equipments (UEs) within a coverage area 120 of gNB 102. The first plurality of UEs comprise a UE 111, which may be located in a Small Business (SB); a UE 112, which may be located in an enterprise (E); a UE 113, which may be located in a WiFi Hotspot (HS); a UE 114, which may be located in a first residence (R); a UE 115, which may be located in a second residence (R); a UE 116, which may be a mobile device (M), such as a cellular phone, a wireless laptop computer, a wireless personal digital assistant (PDA), etc. gNB 103 provides wireless broadband access to network 130 for a second plurality of UEs within a coverage area 125 of gNB 103. The second plurality of UEs comprise a UE 115 and a UE 116. In some embodiments, one or more of gNBs 101-103 can communicate with each other and with UEs 111-116 using 5G, Long Term Evolution (LTE), LTE-advanced (A), WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of gNB 101, gNB 102, and gNB 103 comprise a two-dimensional (2D) antenna array as described in embodiments of the present disclosure. In some embodiments, one or more of gNB 101, gNB 102, and gNB 103 support codebook designs and structures for systems with 2D antenna arrays.

Although FIG. 1 illustrates an example of the wireless network 100, various changes can be made to FIG. 1. The wireless network 100 can comprise any number of gNBs and any number of UEs in any suitable arrangement, for example. Furthermore, gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, gNB 101, 102 and/or 103 can provide access to other or additional external networks, such as external telephone networks or other types of data networks.

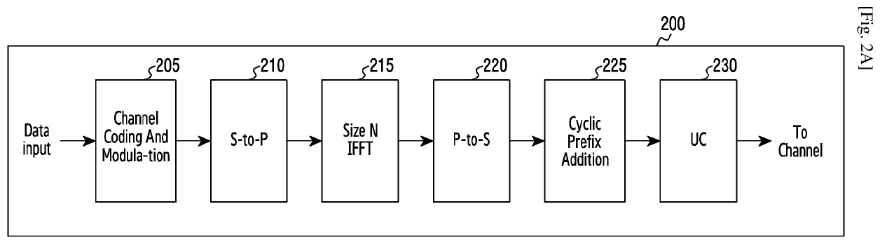

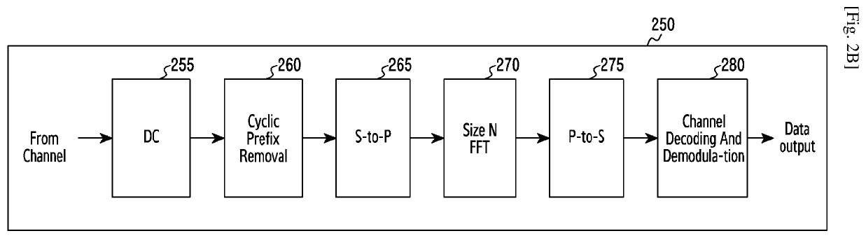

FIGS. 2A and 2B illustrate example wireless transmission and reception paths according to the present disclosure. In the following description, the transmission path 200 can be described as being implemented in a gNB, such as gNB 102, and the reception path 250 can be described as being implemented in a UE, such as UE 116. However, it should be understood that the reception path 250 can be implemented in a gNB and the transmission path 200 can be implemented in a UE. In some embodiments, the reception path 250 is configured to support codebook designs and structures for systems with 2D antenna arrays as described in embodiments of the present disclosure.

The transmission path 200 comprises a channel coding and modulation block 205, a Serial-to-Parallel (S-to-P) block 210, a size N Inverse Fast Fourier Transform (IFFT) block 215, a Parallel-to-Serial (P-to-S) block 220, a cyclic prefix addition block 225, and an up-converter (UC) 230. The reception path 250 comprises a down-converter (DC) 255, a cyclic prefix removal block 260, a Serial-to-Parallel (S-to-P) block 265, a size N Fast Fourier Transform (FFT) block 270, a Parallel-to-Serial (P-to-S) block 275, and a channel decoding and demodulation block 280.

In the transmission path 200, the channel coding and modulation block 205 receives a set of information bits, applies coding (such as Low Density Parity Check (LDPC) coding), and modulates the input bits (such as using Quadrature Phase Shift Keying (QPSK) or Quadrature Amplitude Modulation (QAM)) to generate a sequence of frequency-domain modulated symbols. The Serial-to-Parallel (S-to-P) block 210 converts (such as demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time-domain output signal. The Parallel-to-Serial block 220 converts (such as multiplexes) parallel time-domain output symbols from the Size N IFFT block 215 to generate a serial time-domain signal. The cyclic prefix addition block 225 inserts a cyclic prefix into the time-domain signal. The up-converter 230 modulates (such as up-converts) the output of the cyclic prefix addition block 225 to an radio frequency (RF) frequency for transmission via a wireless channel. The signal can also be filtered at a baseband before switching to the RF frequency.

The RF signal transmitted from gNB 102 arrives at UE 116 after passing through the wireless channel, and operations in reverse to those at gNB 102 are performed at UE 116. The down-converter 255 down-converts the received signal to a baseband frequency, and the cyclic prefix removal block 260 removes the cyclic prefix to generate a serial time-domain baseband signal. The Serial-to-Parallel block 265 converts the time-domain baseband signal into a parallel time-domain signal. The Size N FFT block 270 performs an FFT algorithm to generate N parallel frequency-domain signals. The Parallel-to-Serial block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 2A and 2B can be implemented using only hardware, or using a combination of hardware and software/firmware. As a specific example, at least some of the components in FIGS. 2A and 2B may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the present disclosure. Other types of transforms can be used, such as Discrete Fourier transform (DFT) and Inverse Discrete Fourier Transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2A and 2B illustrate examples of wireless transmission and reception paths, various changes may be made to FIGS. 2A and 2B. For example, various components in FIGS. 2A and 2B can be combined, further subdivided or omitted, and additional components can be added according to specific requirements. Furthermore, FIGS. 2A and 2B are intended to illustrate examples of types of transmission and reception paths that can be used in a wireless network. Any other suitable architecture can be used to support wireless communication in a wireless network.

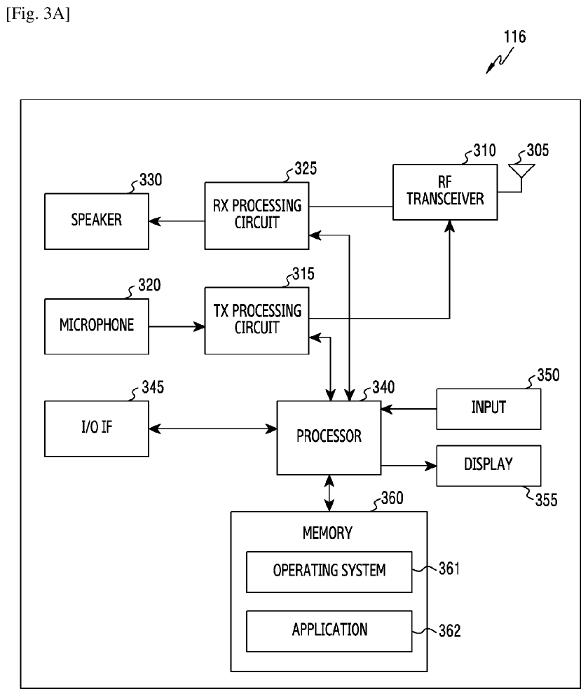

FIG. 3A illustrates an example UE 116 according to the present disclosure. The embodiment of UE 116 shown in FIG. 3A is for illustration only, and UEs 111-115 of FIG. 1 can have the same or similar configuration. However, a UE has various configurations, and FIG. 3A does not limit the scope of the present disclosure to any specific implementation of the UE.

UE 116 comprises an antenna 305, a RF transceiver 310, a transmission (TX) processing circuit 315, a microphone 320, and a reception (RX) processing circuit 325. UE 116 also comprises a speaker 330, a processor/controller 340, an input/output (I/O) interface 345, an input device(s) 350, a display 355, and a memory 360. The memory 360 comprises an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can comprise one or more processors or other processing devices and execute an OS 361 stored in the memory 360 in order to control the overall operation of UE 116. For example, the processor/controller 340 can control the reception of forward channel signals and the transmission of backward channel signals through the RF transceiver 310, the RX processing circuit 325 and the TX processing circuit 315 according to well-known principles. In some embodiments, the processor/controller 340 comprises at least one microprocessor or microcontroller.

The processor/controller 340 is also capable of executing other processes and programs residing in the memory 360, such as operations for channel quality measurement and reporting for systems with 2D antenna arrays as described in embodiments of the present disclosure. The processor/controller 340 can move data into or out of the memory 360 as required by an execution process. In some embodiments, the processor/controller 340 is configured to execute the application 362 based on the OS 361 or in response to signals received from the gNB or the operator. The processor/controller 340 is also coupled to an I/O interface 345, where the I/O interface 345 provides UE 116 with the ability to connect to other devices such as laptop computers and handheld computers. I/O interface 345 is a communication path between these accessories and the processor/controller 340.

The processor/controller 340 is also coupled to the input device(s) 350 and the display 355. An operator of UE 116 can input data into UE 116 using the input device(s) 350. The display 355 may be a liquid crystal display or other display capable of presenting text and/or at least limited graphics (such as from a website). The memory 360 is coupled to the processor/controller 340. A part of the memory 360 can comprise a random access memory (RAM), while another part of the memory 360 can comprise a flash memory or other read-only memory (ROM).

Although FIG. 3A illustrates an example of UE 116, various changes can be made to FIG. 3A. For example, various components in FIG. 3A can be combined, further subdivided or omitted, and additional components can be added according to specific requirements. As a specific example, the processor/controller 340 can be divided into a plurality of processors, such as one or more central processing units (CPUs) and one or more graphics processing units (GPUs). Furthermore, although FIG. 3A illustrates that the UE 116 is configured as a mobile phone or a smart phone, UEs can be configured to operate as other types of mobile or fixed devices.

FIG. 3B illustrates an example gNB 102 according to the present disclosure. The embodiment of gNB 102 shown in FIG. 3B is for illustration only, and other gNBs of FIG. 1 can have the same or similar configuration. However, a gNB has various configurations, and FIG. 3B does not limit the scope of the present disclosure to any specific implementation of a gNB. It should be noted that gNB 101 and gNB 103 can comprise the same or similar structures as gNB 102.

As shown in FIG. 3B, gNB 102 comprises a plurality of antennas 370a-370n, a plurality of RF transceivers 372a-372n, a transmission (TX) processing circuit 374, and a reception (RX) processing circuit 376. In certain embodiments, one or more of the plurality of antennas 370a-370n comprise a 2D antenna array. gNB 102 also comprises a controller/processor 378, a memory 380, and a backhaul or network interface 382.

RF transceivers 372a-372n receive an incoming RF signal from antennas 370a-370n, such as a signal transmitted by UEs or other gNBs. RF transceivers 372a-372n down-convert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and up-convert the baseband or IF signal into an RF signal transmitted via antennas 370a-370n.

The controller/processor 378 may comprise one or more processors or other processing devices that control the overall operation of gNB 102. For example, the controller/processor 378 may control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a Blind Interference Sensing (BIS) process such as that performed through a BIS algorithm, and decode a received signal from which an interference signal is subtracted. A controller/processor 378 may support any of a variety of other functions in gNB 102. In some embodiments, the controller/processor 378 comprises at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described in embodiments of the present disclosure. In some embodiments, the controller/processor 378 supports communication between entities such as web RTCs. The controller/processor 378 can move data into or out of the memory 380 as required by an execution process.

The controller/processor 378 is also coupled to the backhaul or network interface 382. The backhaul or network interface 382 allows gNB 102 to communicate with other devices or systems through a backhaul connection or through a network. The backhaul or network interface 382 may support communication over any suitable wired or wireless connection(s). For example, when gNB 102 is implemented as a part of a cellular communication system, such as a cellular communication system supporting 5G or new radio access technology or NR, LTE or LTE-A, the backhaul or network interface 382 can allow gNB 102 to communicate with other gNBs through wired or wireless backhaul connections. When gNB 102 is implemented as an access point, the backhaul or network interface 382 can allow gNB 102 to communicate with a larger network, such as the Internet, through a wired or wireless local area network or through a wired or wireless connection. The backhaul or network interface 382 comprises any suitable structure that supports communication through a wired or wireless connection, such as an Ethernet or an RF transceiver.

The memory 380 is coupled to the controller/processor 378. A part of the memory 380 can comprise an RAM, while another part of the memory 380 can comprise a flash memory or other ROMs. In certain embodiments, a plurality of instructions, such as the BIS algorithm, are stored in the memory. The plurality of instructions are configured to cause the controller/processor 378 to execute the BIS process and decode the received signal after subtracting at least one interference signal determined by the BIS algorithm.

As will be described in more detail below, the transmission and reception paths of gNB 102 (implemented using RF transceivers 372a-372n, TX processing circuit 374 and/or RX processing circuit 376) support aggregated communication with frequency division duplex (FDD) cells and time division duplex (TDD) cells.

Although FIG. 3B illustrates an example of gNB 102, various changes may be made to FIG. 3B. For example, gNB 102 can comprise any number of each component shown in FIG. 3A. As a specific example, the access point can comprise many backhaul or network interfaces 382, and the controller/processor 378 can support routing functions to route data between different network addresses. As another specific example, although shown as including a single instance of the TX processing circuit 374 and a single instance of the RX processing circuit 376, gNB 102 may comprise multiple instances of each (such as one for each RF transceiver).

Exemplary embodiments of the present disclosure are further described below in conjunction with the accompanying drawings.

The text and figures are provided as examples only to assist the reader in understanding the present disclosure. They are not intended and should not be construed as limiting the scope of the present disclosure in any way. While certain embodiments and examples have been provided, based on what is disclosed herein it will be apparent to those skilled in the art that variations to the illustrated embodiments and examples may be made without departing from the scope of the present disclosure.

The demand for use of wireless data is increasing in the producing activities of human's society, and the spectrum is becoming a scarce resource. How to improve the utilization of the spectrum of a communication system has always been a hot issue for practitioners. At present, the low-frequency resources of the wireless communication are crowded, and the operating frequency band of the communication system is gradually developing towards higher frequency, so there will be an inevitably conflict of resources with a radar system that originally operated in high frequency band. There is a very high similarity between a cellular communication system and a radar system in terms of background theoretical knowledge and hardware structure. Therefore, an integration of the cellular communication system and the radar system may be used as a potential means to improve the spectrum efficiency. At the same time, the communication system and the radar system may also complement for each other in performance, achieving a mutual benefit and a win-win outcome. Therefore, integrated sensing and communications (hereinafter referred to as ISAC), as a hot research direction in the communication field, has become one of the candidate technologies of the sixth generation (6G). The core of an ISAC system is to use the same set of hardware device, and realize a sensing function of the surrounding environment, on the basis of ensuring basic communication functions, at an expense of resource overhead as little as possible. The sensed content includes distance, orientation, velocity and even types etc. of objects in the surrounding environment. Unlike the technology of locating the access terminal in the communication system, ISAC technology can also realize the sensing of various information of non-access objects, which greatly improves the ability of communication system to dynamically adjust the operating state (scheduling, beam management, early warning of access terminals, etc.) according to the surrounding environment.

In a potential application scenario of the technology of integrated sensing and communications, compared with an independent radar system, a device with capability of integrated sensing and communications usually does not have particularly high signal transmission power, so the device with capability of integrated sensing and communications usually can only sense the environment in a close range (e.g., hundreds of meters), and in turn while transmitting signals, the echo signals already in the environment (the received signals resulting from reflecting or scattering back the transmitted signal passing through the target point in the environment) need to be received by the receiver, which requires the technology of integrated sensing and communications to require the nodes performing environmental sensing to have the capability of full duplex (full duplex: transmitting and receiving at the same time and with the same frequency). From a analysis of the propagation characteristics of electromagnetic waves, it can be seen that the energy of the signal directly leaked from the transmitter to the receiver and the energy of the echo signal passing through close objects are much higher than that of the echo signal of a long-distance target (and a weak-scattering target). If interference cancellation is not performed, such high-energy signals will have a great impact on the identification of long-distance targets and weak-scattering targets. Based on this, interference cancellation is the basis to guarantee that long-range targets and weak-scattering targets in the environment can be detected successfully, and it is also the enabling technology to guarantee proper function of a system of integrated sensing and communications.

When the ISAC system is running, a sensing node (a node performing environmental sensing) may use a variety of different beams to sense (targets). It should be noted that in all embodiments of the present disclosure, target sensing includes but is not limited to: detecting (sensing) whether there is a target (also referred to as “target detection”), detecting (sensing) a distance of the target, detecting (sensing) an angle of the target, and so on. Target sensing is performed based on a received signal (e.g., an echo signal of a transmitted sensing signal), so it can also be referred to as received signal estimation.

Various beams used by the sensing node are affected by the above interference, so in the ISAC system, it is necessary to perform interference cancellation on the received signals of various beams used by the sensing node. For example, when performing target angle estimation, the sensing node may use the sum-differential beamforming technology to obtain signals of a sum beam and a differential beam, respectively, for target detection and target angle estimation. For example, an antenna array may be divided into two sub-arrays, and a sum beam channel and a differential beam channel may be obtained by summing and subtracting the two sub-arrays respectively. For example, a sum beam may be used to detect a distance of the target. For example, the distance of the target may be determined by using a time difference of the received echo signal of the sum beam. For example, an approximate angle of the target may be determined by using the sum beam, that is, the target is within the beam width of the sum beam. A differential beam may be used to detect angle information of the target (e.g., azimuth or elevation angle information). If the target is just in the direction of the maximum sum beam, the received signal of the differential beam is weak (e.g., at a value of zero), and when the target is moving, the received signal of the differential beam changes from weak to strong, that is, the angle (azimuth or elevation angle) direction of the target may be determined according to the signal of the differential beam. When the azimuth angle information of the target is to be detected, the two sub-arrays may be arranged left and right. When the elevation angle information of the target is to be detected, the two sub-arrays may be arranged up and down. When both the azimuth and elevation angle information of the target are to be detected, the array maybe divided into a plurality of sub-arrays (e.g., four sub-arrays of an upper left sub-array, a lower left sub-array, an upper right sub-array and a lower right sub-array), so as to obtain the differential beam signals in two directions corresponding to the azimuth and elevation angle directions respectively. Various beams used by the sensing node (e.g., sum beam and differential beam) are affected by self-interference.

In view of this, the present disclosure mainly relates to the sensing function and/or the communication function of a node of integrated sensing and communications, and proposes a node of integrated sensing and communications and a method performed by the node of integrated sensing and communications. Hereinafter, a node of integrated sensing and communications is referred to as a sensing node for short, and a sensing node may be any wireless communication device, such as base station, terminal device, bypass device etc.

At present, the most widely applied communication systems are those based on 3GPP protocol, for example, 4G communication systems such as LTE and LTE-A, and 5G communication systems such as NR. The signal waveforms employed by such communication systems are all based on OFDM-modulated waveforms. Considering forward compatibility, for example, an OFDM communication signals may be used as a sensing signal. Specifically, a sensing signal may be a physical signal and/or a physical channel that may be transmitted for sensing purposes. For example, when the sensing node is a base station, the sensing signal may be a downlink reference signal or a downlink physical channel etc. When the sensing node is a terminal, the sensing signal may be an uplink reference signal or an uplink physical channel etc. The sensing signal transmitted by the sensing node is re-received by the sensing node in the form of echo signal after being reflected via the target reflector. The sensing information such as distance, velocity and orientation, of the target object can be sensed by means of signal processing on the echo signal.

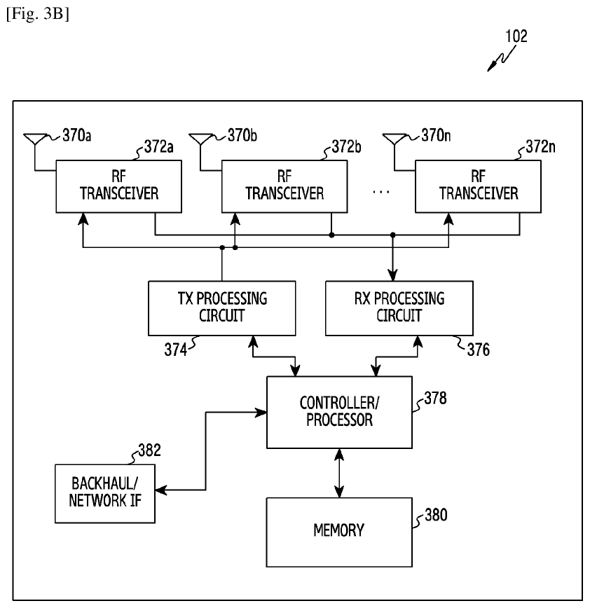

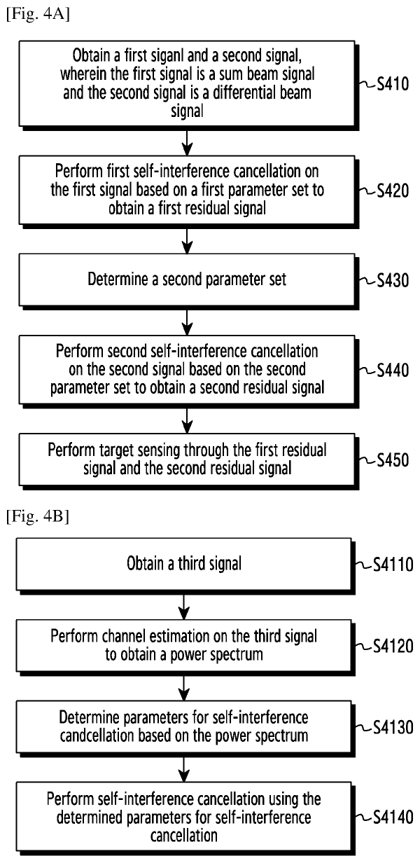

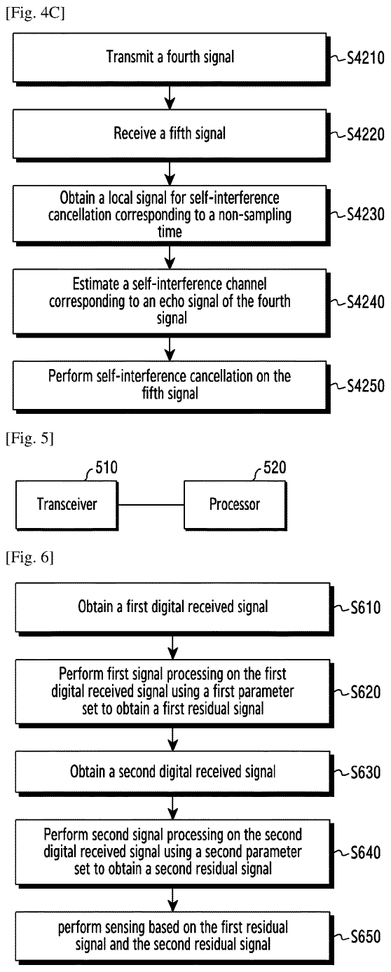

Next, a method performed by a wireless communication device according to an embodiment of the present disclosure will be described with reference to FIGS. 4 to 22.

FIGS. 4A to 4C are flowcharts illustrating methods performed by a device in a wireless communication system according to the present disclosure. The device may be any wireless communication device, which may be used interchangeably with the “sensing node” mentioned herein, and may be, for example, a base station, a terminal device, a bypass device, etc.

In step 410, the device obtains a first signal and a second signal, wherein the first signal is a sum beam signal and the second signal is a differential beam signal.

In step 420, the device performs first self-interference cancellation on the first signal based on a first parameter set to obtain a first residual signal.

In step 430, the device determines a second parameter set.

In step 440, the device performs second self-interference cancellation on the second signal based on the second parameter set to obtain a second residual signal.

In step 450, the device performs target sensing through the first residual signal and the second residual signal.

According to an embodiment of the present disclosure, the second parameter set is determined based on at least one of the first parameter set, the first signal and the second signal.

According to one or more embodiments of the present disclosure, the second parameter set includes an order of the second self-interference cancellation and/or channel paths of the second self-interference cancellation.

According to one or more embodiments of the present disclosure, determining the second parameter set includes at least one of: determining the order of the second self-interference cancellation based on an order of the first self-interference cancellation in the first parameter set; determining a first order based on a result of comparison between a power value of each order component of a first reconstructed signal and a power value of the second signal, and determining the order of the second self-interference cancellation based on the first order; determining a first order based on a result of comparison between a power value of each order component of a first reconstructed signal and a power value of the second signal, and determining the order of the second self-interference cancellation based on the first order and an order of the first self-interference cancellation in the first parameter set; wherein the first reconstructed signal is a signal cancelled when the first self-interference cancellation is performed on the first signal.

According to an embodiment of the present disclosure, determining the first order based on a result of comparison between a power value of each order component of a first reconstructed signal and a power value of the second signal comprises: determining the first order as 0 in the case that the power value of the component of each order of the first reconstructed signal is greater than or equal to the power value of the second signal; and determining the first order as the minimum value of a component order of a at least first-order of the first reconstructed signal in the case that the power value of the at least first-order components of the first reconstructed signal is smaller than the power value of the second signal.

According to one or more embodiments of the present disclosure, determining the second parameter set comprises determining the channel paths of the second self-interference cancellation based on the channel paths of the first self-interference cancellation in the first parameter set; obtaining a first power spectrum corresponding to the first signal and a second power spectrum corresponding to the second signal, and determining a second channel path(s) based on the first power spectrum and the second power spectrum, and determining the channel paths of the second self-interference cancellation based on the second channel path(s); obtaining a first power spectrum corresponding to the first signal and a second power spectrum corresponding to the second signal, determining a second channel path(s) based on the first power spectrum and the second power spectrum, and determining the channel paths of the second self-interference cancellation based on the channel paths of the first self-interference cancellation and the second channel path(s) in the first parameter set; wherein the first power spectrum represents a correspondence between distances and powers of a result of channel estimation of the first signal, and the second power spectrum represents a correspondence between distances and powers of a result of channel estimation of the second signal, or the first power spectrum represents a correspondence between both distances and velocities and powers of a result of channel estimation of the first signal, and the second power spectrum represents a correspondence between both distances and velocities and powers of a result of channel estimation of the second signal.

According to one or more embodiments of the present disclosure, determining the first channel path(s) based on the first power spectrum and the second power spectrum comprises: determining the first channel path(s) based on a first distance corresponding to a first sample in the second power spectrum that meets a first condition, and wherein the first condition is that a difference between a power value corresponding to the first sample in the second power spectrum and a noise floor power value in the second power spectrum is greater than or equal to a difference between the maximum power value in the first power spectrum and a noise floor power value in the first power spectrum. Wherein the power spectrum may be a distance spectrum or a distance-velocity spectrum.

According to an embodiment of the present disclosure, a sum beam signal and a differential beam signal are obtained based on a first sensing signal and a second sensing signal; wherein the second sensing signal is a signal resulting from transforming the first sensing signal into time domain by adding linear phase rotation to the first sensing signal in frequency domain. More specifically, the first sensing signal and the second sensing signal are discrete signals resulting from sampling a same analog signal at the same sampling starting time or different sampling starting times.

In FIG. 4B, in step 4110, a wireless communication device (which may also be a communication node or a sensing node, and the same applies hereinafter) obtains a third signal. In step 4120, the wireless communication device performs channel estimation on the third signal to obtain a power spectrum. In step 4130, the wireless communication device determines a parameter(s) for self-interference cancellation based on the power spectrum. In step 4140, the wireless communication device performs self-interference cancellation using the determined parameters for self-interference cancellation.

According to various embodiments of the present disclosure, the parameters include at least one of indexes of channel paths of self-interference cancellation, an index set of channel paths of self-interference cancellation, an order of self-interference cancellation, and an order corresponding to a channel path of self-interference cancellation. That is, in step 4130, at least one of indexes of channel paths of self-interference cancellation, an index set of channel paths of self-interference cancellation, an order of self-interference cancellation, and an order corresponding to a channel path of self-interference cancellation may be determined based on the power spectrum, and the self-interference cancellation may be performed using the calculated parameters above.

When the parameter(s) is the indexes of the channel paths of self-interference cancellation, determining parameters for self-interference cancellation based on the power spectrum comprises determining channel paths corresponding to samples in the power spectrum that are above a predetermined threshold as the parameters for self-interference cancellation. The power spectrum includes at least one of the distance spectrum and the distance-velocity spectrum as mentioned above.

When the parameter(s) is an index set of channel paths of self-interference cancellation, determining the parameter for self-interference cancellation based on the power spectrum comprises performing a detection algorithm based on the power spectrum so as to obtain a first index set of channel paths of self-interference cancellation; and determining a third index set of channel paths of self-interference cancellation based on the first index set of channel paths of self-interference cancellation and a second index set of channel paths of self-interference cancellation, wherein the second index set of channel paths of self-interference cancellation may be predetermined or configured.

The above-mentioned third index set of channel paths of self-interference cancellation comprises a union of the first index set of channel paths of self-interference cancellation and the predetermined or configured second index set of channel paths of self-interference cancellation, or an intersection of the first index set of channel paths of self-interference cancellation and the predetermined second index set of channel paths of self-interference cancellation. Of course, the third index set of channel paths of self-interference cancellation may also be other combinations or calculations for the first index set of channel paths of self-interference cancellation and the predetermined or configured second index set of channel paths of self-interference cancellation.

When the parameter(s) is the order corresponding to the channel paths of self-interference cancellation, determining parameters for self-interference cancellation based on the power spectrum comprises comparing a power corresponding to each channel path in the power spectrum with a set threshold, and determining an order of self-interference cancellation corresponding to a respective channel path based on a result of comparison. In one embodiment, a higher order of self-interference cancellation may be set for the channel path with higher power in the power spectrum.

In FIG. 4C, in step 4210, the wireless communication device transmits a fourth signal. In step 4220, the wireless communication device receives a fifth signal. In step 4230, the wireless communication device obtains a local signal for self-interference cancellation corresponding to a non-sampling time based on the fourth signal. In step 4240, the wireless communication device estimates a self-interference channel corresponding to an echo signal of the fourth signal based on the local signal for self-interference cancellation obtained according to the fourth signal. In step 4250, the wireless communication device performs self-interference cancellation on the fifth signal based on the self-interference channel.

In a more specific embodiment, a self-interference reconstructed signal may be obtained based on the fourth signal and a self-interference channel corresponding to an echo signal of the fourth signal. The self-interference cancellation may be performed on the fifth signal based on the self-interference reconstructed signal.

In an embodiment, the fifth signal may be an echo signal corresponding to the fourth signal.

In an embodiment, the fifth signal may be an echo signal corresponding to a sixth signal different from the fourth signal.

At this time, performing self-interference cancellation on the fifth signal is also based on a transmitted signal corresponding to the fifth signal, or the local signal for self-interference cancellation corresponding to the non-sampling time obtained according to a transmitted signal corresponding to the fifth signal. Alternatively, performing self-interference cancellation on the fifth signal further comprises: obtaining a self-interference reconstructed signal based on a self-interference channel corresponding to an echo signal of the fourth signal and a transmitted signal corresponding to the fifth signal; and performing self-interference cancellation on the fifth signal based on the self-interference reconstructed signal.

In an embodiment, the local signal may correspond to the fourth signal or a transmitted signal corresponding to the fifth signal, both of which may be obtained by: obtaining a frequency domain signal corresponding to the transmitted signal (which may be the fourth signal or the transmitted signal corresponding to the fifth signal according to the purpose); adding linear phase rotation to the frequency domain signal to obtain a frequency domain signal with linear phase rotation, wherein the linear phase rotation is related to one or more delays in which the sampling time is away from the non-sampling time; and transforming the frequency domain signal with linear phase rotation into a time domain signal to obtain the local signal. Wherein the sampling time may be either a sampling starting time, or a latest sampling time before a non-sampling time.

According to an embodiment of the present disclosure, the delay may be either preset, or obtained based on a delay ratio parameter and a signal sampling rate.

According to an embodiment of the present disclosure, the delay ratio parameter is determined according to the index set of channel paths and the power spectrum.

According to an embodiment of the present disclosure, a local signal is calculated for each element in the index set of channel paths.

According to an embodiment of the present disclosure, calculating the local signal for each element in the index set of channel paths further comprises: calculating, for an element in the index set of channel paths, a local signal corresponding to the element, and obtaining local signals corresponding to other elements in the index set of channel paths by means of cyclic shift; or determining, for each element in the index set of channel paths, a delay respectively corresponding to the element, and obtaining, for each element in the index set of channel paths, a local signal corresponding to the element, based on the calculated delay.

According to an embodiment of the present disclosure, the index set of channel paths is obtained based on both of: a third index set of channel paths of self-interference cancellation obtained by performing a detection algorithm based on the power spectrum; and a predetermined or configured fourth index set of channel paths of self-interference cancellation.

According to an embodiment of the present disclosure, wherein the index set of channel paths of self-interference cancellation includes a union of the third index set of channel paths of self-interference cancellation and the predetermined or configured fourth index set of channel paths of self-interference cancellation, or an intersection of the third index set of channel paths of self-interference cancellation and the predetermined or configured fourth index set of channel paths of self-interference cancellation.

According to an embodiment of the present disclosure, the power spectrum includes at least one of a distance spectrum and a distance-velocity spectrum.

According to an embodiment of the present disclosure, performing self-interference cancellation on the fifth signal further comprises: obtaining a self-interference reconstructed signal based on a self-interference channel corresponding to an echo signal of the fourth signal and the local signal for self-interference cancellation corresponding to the non-sampling time obtained according to a transmitted signal corresponding to the fifth signal; and performing self-interference cancellation on the fifth signal based on the self-interference reconstructed signal.

FIG. 5 is a block diagram illustrating a communication device according to the present disclosure.

FIG. 5 is a block diagram of a wireless communication device according to the present disclosure. The wireless communication device may be any wireless communication device, which may be used interchangeably with the “sensing node” mentioned herein, and may be, for example, a base station, a terminal device, a bypass device, etc. Referring to FIG. 5, a communication device according to the present disclosure includes a transceiver 510 and a processor 520. The transceiver 510 and the processor 520 are configured to perform the operations of various embodiments of the present disclosure. Although the transceiver 510 and the processor 520 are shown as separate entities, they may be implemented as a single entity, such as a single chip. The transceiver 510 and the processor 520 may be electrically connected or coupled to each other. The transceiver 510 may transmit signals to and receive signals from other network devices, such as UEs, base stations or core network nodes. The processor 520 may include one or more processing units and may control the network device to perform the operations and/or functions according to at least one of the above embodiments.

As an example, the wireless communication device may be a personal computer (PC), a tablet device, a personal digital assistant, a smart phone, or other devices capable of executing the above instruction set. Here, the electronic device does not have to be a single electronic device, but may also be a collection of any devices or circuits capable of executing the above instructions (or instruction sets) individually or jointly. The electronic device may also be part of an integrated control system or system manager, or may be configured as a portable electronic device that interconnects with local or remote (e.g., via wireless transmission) interfaces.

In the communication device, a processor may include a central processing unit (CPU), a graphics processor (GPU), a programmable logic device, a dedicated processor system, a microcontroller or a microprocessor. By way of example and not limitation, a processor may further include an analog processor, a digital processor, a microprocessor, a multi-core processor, a processor array, a network processor, and the like.

A processor may execute instructions or codes stored in a memory, which may also store data. Instructions and data may also be transmitted and received through a network via a network interface device, wherein the network interface device may employ any known transmission protocol.

The memory may be integrated with the processor, for example, an RAM or a flash memory is arranged in an integrated circuit microprocessor or the like. Furthermore, the memory may include independent devices, such as external disk drives, storage arrays, or other storage devices usable by any database system. The memory and the processor may be operatively coupled, or may communicate with each other, for example, through an I/O port, a network connection, etc., so that the processor can read files stored in the memory.

In addition, the wireless communication device may further include a video display (such as a liquid crystal display) and a user interaction interface (such as a keyboard, a mouse, a touch input device, etc.). All components of the electronic device may be connected to each other via a bus and/or a network. FIG. 6 is a flowchart illustrating a method performed by a wireless communication device according to an embodiment of the present disclosure.

Referring to FIG. 6, in step S610, the wireless communication device may obtain a first digital received signal (also referred to as a first signal).

It should be noted that, in all embodiments herein, a distance-velocity spectrum obtained according to the first digital received signal is referred to as a “first distance-velocity spectrum”, a distance-velocity spectrum obtained according to a second digital received signal is referred to as a “second distance-velocity spectrum”, a distance-velocity spectrum obtained according to a first residual signal is referred to as a “third distance-velocity spectrum”, and a distance-velocity spectrum obtained according to a second residual signal is referred to as a “fourth distance-velocity spectrum”. It should be noted that the meanings of the first digital received signal, the second digital received signal, the first residual signal and the second residual signal will be explained below.

It should be noted that, in all embodiments herein, the first digital received signal may be a sum beam signal. The sum beam signal may be a signal received through a sum beam channel of an antenna array of the wireless communication device after the wireless communication device transmits a first sensing signal. The second digital received signal may be a differential beam signal. The differential beam signal may be a signal received through a differential beam channel of the antenna array of the wireless communication device after the wireless communication device transmits a second sensing signal. The first sensing signal and the second sensing signal may be the same signal. Alternatively, the first sensing signal and the second sensing signal may be the same signal transmitted at different times and with the same signal characteristics. For example, signal characteristics refer to waveform, magnitude, phase and so on. Alternatively, the first sensing signal and the second sensing signal may be different signals transmitted at different times but associated with each other. For example, the second sensing signal may be a signal resulting from transforming the first sensing signal into time domain by adding linear phase rotation to the first sensing signal in frequency domain, that is, the second sensing signal and the first sensing signal may be discrete signals corresponding to the same analog signal but after being sampled at different sampling starting times.

For example, the first digital received signal may be obtained by performing a first (digital) received beam sweeping, or obtained based on signals received by a plurality of sub-arrays of a receiving antenna panel of the wireless communication device. For example, the first digital received signal may be an echo signal corresponding to the first digital received signal, received by the wireless communication device after the sensing signal (or sounding signal) transmitted by the wireless communication device is reflected by the target reflector. For example, it is assumed that the first digital received signal in time domain within the receiving window is y[n], where n=0, 1, . . . , N_{FFT}−1, N_{FFT} is the number of samples for Fourier Transform, and the vector form of y[n] is

$$y = [ \begin{matrix}y [ 0 ] \\ ⋮ \\ y [ {N}_{FFT} - 1 ]\end{matrix} ] .$$

In step S620, the wireless communication device may perform first signal processing on the first digital received signal using a first parameter set to obtain a first residual signal. For example, the first parameter set may be preset or configured by a higher layer, or may be calculated in real time based on the first digital received signal. According to an embodiment of the present disclosure, for example, the first digital received signal may be a sum beam received signal, the first signal processing may be self-interference cancellation, and accordingly, the first parameter set may include self-interference cancellation parameters for cancelling self-interference signals formed by the transmitted sensing signal from the first digital received signal. The self-interference cancellation parameters are related to a result of self-interference channel estimation. For example, the self-interference cancellation parameters may include order and channel paths for self-interference cancellation. The first residual signal may be a signal resulting from performing self-interference cancellation on the first digital received signal. For example, the sum beam received signal may be a signal received through a sum beam channel of the receiving antenna panel of the wireless communication device. For example, the sum beam channel may be obtained by adding the directional patterns of two sub-arrays of the receiving antenna panel of the wireless communication device.

For example, the first parameter set may include channel paths and the order for self-interference cancellation, where L denotes the number of channel paths of self-interference cancellation, then an index set of channel paths for self-interference cancellation may be Idx={0, 1, . . . , L−1}, and P denotes the order of self-interference cancellation, where P may be an odd number greater than or equal to 1, for example, 1, 3, 5, etc. When the first signal processing is self-interference cancellation, one possible implementation may be that the wireless communication device transmits a local signal and receives an echo signal at the same time, wherein the echo signal contains a signal resulting from the transmitted signal being reflected by the target and an interference signal resulting from the local signal passing through the self-interference channel, and performs estimation on the self-interference channel based on the local signal and the echo signal containing the interference signal. It is assumed that the local (time domain) signal for self-interference cancellation is s[n], where n=0, 1, . . . , N_{FFT}−1, then a time domain first-order component convolution matrix S₁ constructed from s[n] is:

$${S}_{1} = [ \begin{matrix}s [ 0 ] & s [ {N}_{FFT} - 1 ] & … & s [ 2 ] & s [ 1 ] \\ s [ 1 ] & s [ 0 ] & … & s [ 3 ] & s [ 2 ] \\ ⋮ & ⋮ & ⋱ & ⋮ & ⋮ \\ s [ {N}_{FFT} - 2 ] & s [ {N}_{FFT} - 3 ] & … & s [ 0 ] & s [ {N}_{FFT} - 1 ] \\ s [ {N}_{FFT} - 1 ] & s [ {N}_{FFT} - 2 ] & … & s [ 1 ] & s [ 0 ]\end{matrix} ]$$

That is, the first column of S₁ is s[n], and each column hereafter is a downward cyclic shift of the previous column. Taking the order of self-interference cancellation as three or five as an example, a possible implementation of constructing the third-order component and the fifth-order component of the local signal is given below. The time-domain convolution matrices of the third-order component and the fifth-order component are constructed from the time-domain convolution matrix S₁ of the first-order component, which are S₃=S₁⊙|S₁|² and S₅=S₁⊙|S₁|⁴, respectively, where |·|² and |·|⁴ respectively represent element-wise square and fourth power of absolute values, ⊙ represents an element-wise multiplication of a matrix, and both operation priorities of |·|² and |·|⁴ are higher than that of ⊙. According to the cancellation order P, the sub-array Xᵢₙᵢₜ is extracted from S. If P=1, Xᵢₙᵢₜ a matrix composed of the first L columns of S₁; if P=3, Xᵢₙᵢₜ is a matrix composed of the first L columns of S₁ and the first L columns of S₃ in order; or if P=5, Xᵢₙᵢₜ is a matrix composed of the first L columns of S₁, the first L columns of S₃, and the first L columns of S₅ in order.

Calculating an initial self-interference channel estimate ĥᵢₙᵢₜ, one possible implementation method is as follows:

$${\hat{h}}_{i n i t} = {( {X}_{init}^{H} {X}_{init} + λ I )}^{- 1} {X}_{i n i t}^{H} y$$

Where λ may be a preset value, such as a very small non-negative number, e.g.,

10⁻¹⁰, 10⁻⁵, 10⁻¹ etc., the upper corner mark H indicates Hermite transposition, and I is an identity matrix. If the local signal s[n] can be known by the wireless communication device in advance, such as a reference signal, for the initial self-interference channel estimation with fixed path indexes of self-interference cancellation,

$${( {X}_{init}^{H} {X}_{init} + λ I )}^{- 1} {X}_{i n i t}^{H}$$

can be calculated off-line in advance and stored in the storage resources of hardware, and can be directly invoked and multiplied with y when self-interference channel estimation is needed, without online dynamic calculation. A first reconstructed signal after self-interference cancellation is y_{recon1}=xᵢₙᵢₜĥᵢₙᵢₜ, and the first reconstructed signal represents the self-interference on the wireless communication device resulting from the sensing signal transmitted by the wireless communication device, and is a self-interference signal. For example, the first reconstructed signal may be an intermediate result in the process of obtaining the first residual signal by performing the first signal processing on the first digital received signal using the first parameter set. For example, in this embodiment, the first reconstructed signal is a product of the local signal and the channel estimate that corresponds to the order of self-interference cancellation and the channel paths of self-interference cancellation corresponding to the first parameter set. Moreover, the residual signal after self-interference cancellation, i.e., the first residual signal, may be yᵣₑₛ₁=y−y_{recon1}.

The first residual signal represents a signal resulting from cancelling the self-interference on the wireless communication device caused by the sensing signal transmitted by the wireless communication device from the first digital received signal. That is, the first residual signal represents a signal resulting from performing self-interference cancellation on the signal received by the wireless communication device.

Optionally, the method shown in FIG. 6 may further comprises: performing a first (digital) received beam sweeping. For example, a sum beam sweeping may be performed. In an example that the receiving antenna panel of the wireless communication device is a linear array, the beamforming coefficient of the sum beam may be:
[1, e^{j2πsi (θ)d/λ}, . . . , e^{j2π(N-1)sin(θ)d/λ}]

Where θ is the beam sweeping angle, d is the spacing between antenna elements, λ is the wavelength, and N is the number of antenna elements. For example, the sum beam sweeping may be a sum of the sweeping results of the antenna array of the receiving antenna panel of the wireless communication device after having phase weighting performed on them. Therefore, the sum beam signal may be a signal resulting from summing the received signals of the antenna array of the receiving antenna panel of the wireless communication device after having phase weighting performed on them.

Optionally, in the process of performing the sum beam sweeping, sweeping may be performed for multiple times on the same sum beam (e.g., a sum beam corresponding to the same angle), that is, the same transmitted signal is transmitted for multiple times on the same sum beam, and a corresponding plurality of different sum beam signals are obtained.

Optionally, the method shown in FIG. 6 may further comprises: performing target detection according to the first residual signal. For example, for each first digital received beam, after obtaining the first digital received signal, the first signal processing is performed on the first digital received signal using the first parameter set to obtain the first residual signal. A third distance spectrum or a third distance-velocity spectrum may be obtained from according to the first residual signal, and target detection may be performed according to the third distance spectrum or the third distance-velocity spectrum. For example, when a certain sum beam is swept once in the process of performing the sum beam sweeping, discrete Fourier transform (DFT) or fast Fourier transform (FFT) may be performed on the first residual signal to obtain the third distance spectrum. For another example, when a certain sum beam is used for multiple times to obtain a plurality of sum beam signals and the first signal processing is performed for multiple times to obtain a plurality of first residual signals in the process of performing the sum beam sweeping, 2D-DFT may be performed on the plurality of first residual signals to obtain the third distance-velocity spectrum (or distance spectrum). In the distance-velocity spectrum, the horizontal and vertical coordinates are distance and velocity respectively, and the corresponding coordinate values are power values. The higher the measured value (e.g., (received) power value) of each sample (distance and velocity) in the distance-velocity spectrum is, the greater the indicated possibility that there is a target here is. Therefore, the distance and velocity of the target may be obtained by searching the peak of the measured value in the third distance-velocity spectrum. However, the wireless communication device may also want to obtain angle information of the target, such as azimuth and elevation angle.

It should be noted that, in all embodiments herein, the distance-velocity spectrum may be replaced by the distance spectrum to realize the functions performed by the distance-velocity spectrum in the method herein. In the distance-velocity spectrum, the horizontal and vertical coordinates are distance and velocity respectively, and the corresponding coordinate values are power. The distance-velocity spectrum represents a correspondence between both the distances and velocities and the powers. The horizontal and vertical coordinates of the distance spectrum are the distance and power values respectively. The distance spectrum represents a correspondence between the distance and the power. The higher the measured value (e.g., (received) power value) of each sample (distance) in the distance spectrum and the distance-velocity spectrum is, the greater the indicated possibility that there is a target here is. Therefore, the distance of the target may be obtained by searching the peak of the measured value in the distance spectrum and the distance-velocity spectrum. The distance spectrum and the distance-velocity spectrum may be collectively referred to as distance-power mapping relationship. The distance spectrum and the distance-velocity spectrum may also be collectively referred to as power spectrum.

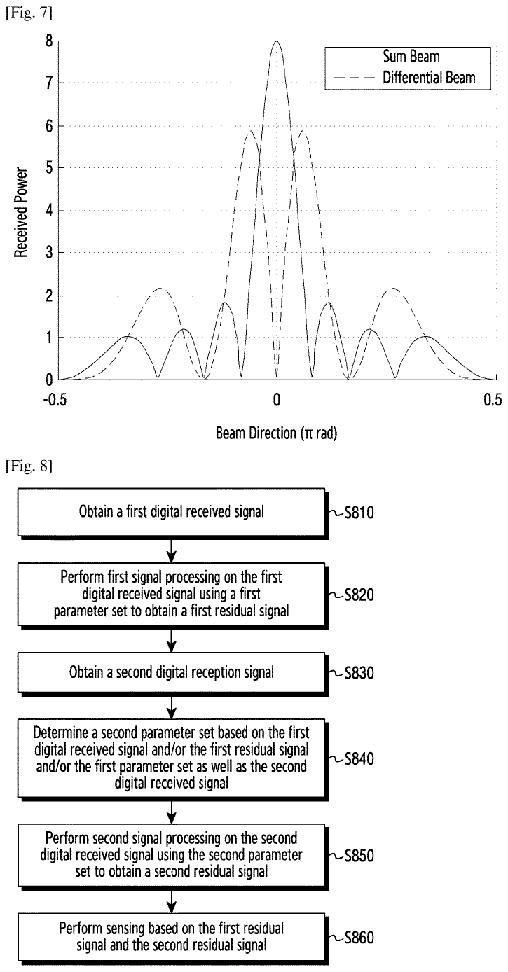

If a target is detected within the coverage of a certain first digital received beam, in order to further obtain the angle information of the target, in step S630, the wireless communication device may obtain a second digital received signal (also referred to as a second signal). However, it should be noted that, in all embodiments herein, the timing for receiving the second digital received signal is not limited to this, and the second digital received signal may be received at the same time as the first digital received signal, and then be stored. According to an embodiment, the second digital received signal may be obtained by performing a second (digital) received beam sweeping, or may be obtained based on signals received by a plurality of sub-arrays of the receiving antenna panel. Specifically, according to an embodiment, the first digital received beam may be a sum beam and the second digital received beam may be a differential beam. For example, the differential beam may be a differential beam corresponding to the sum beam, and its beam pattern is shown in FIG. 7. For example, a differential beam sweeping may be a subtraction between the sweeping results of the (e.g., two) antenna arrays of the receiving antenna panel of the wireless communication device after having phase weighting performed on them. Therefore, the differential beam signal may be a signal resulting from a subtraction of the received signals of the antenna array of the receiving antenna panel of the wireless communication device after performing phase weighting on them.

In step S640, the wireless communication device may perform second signal processing on the second digital received signal using a second parameter set to obtain a second residual signal. For example, when the second signal processing is self-interference cancellation, the second parameter set may include self-interference cancellation parameters for cancelling the self-interference signal formed by the transmitted sensing signal from the second digital received signal. The self-interference cancellation parameters are related to a result of self-interference channel estimation. For example, when the self-interference cancellation parameters may include the order and channel paths for self-interference cancellation, the second residual signal may be a signal resulting from cancelling the self-interference on the wireless communication device caused by the sensing signal transmitted by the wireless communication device from the second digital received signal. Wherein the second parameter set may be the same as the first parameter set or different from the first parameter set. By performing self-interference cancellation not only on the sum beam signal, but also on the differential beam signal, the self-interference signals in sum and differential beam signals may be eliminated, so that more accurate results of target sensing can be obtained when using sum and differential beam signals for target sensing.

In step S650, the wireless communication device may perform sensing (also referred to as received signal estimation) based on the first residual signal and the second residual signal. For example, the wireless communication device may determine the distance of the target based on the first residual signal. For example, an approximate angle of the target may also be determined based on the first residual signal. For example, the wireless communication device may estimate the angle of the target based on the second residual signal or both the first residual signal and the second residual signal. Next, the content related to performing sensing according to an embodiment of the present disclosure will be described first. Hereinafter, the content related to a sensing method of the embodiments of the present disclosure will be described in an example that performing sensing is performing angle estimation. However, performing sensing in the present disclosure is not limited to performing angle estimation, but may further include, for example, performing distance estimation and velocity estimation of the target.

One possible implementation of performing angle estimation may be to perform target detection according to the third distance-velocity spectrum to obtain a first position and a first measured (detected) value, and then to perform sensing according to the first position, the first measured value and the second residual signal (also referred to as received signal estimation). Taking an estimation of the target angle as an example, one possible implementation may be to obtain the third distance-velocity spectrum according to the first residual signal, and to perform target detection according to the third distance-velocity spectrum. For example, a 2D-DFT may be performed on the first residual signal to obtain the third distance-velocity spectrum. The horizontal and vertical coordinates of the distance-velocity spectrum are distance and velocity, respectively. The higher the measured value (e.g., received power value) of each sample in the distance-velocity spectrum is, the greater the indicated possibility that there is a target here is. Therefore, target detection may be performed according to the third distance-velocity spectrum. For example, when the measured value (e.g., received power value) of a certain sample in the distance-velocity spectrum is higher than a certain preset threshold, the first position may be the distance and velocity corresponding to the sample, and the first measured value may be the power value of the sample. A 2D-DFT is performed on the second residual signal to obtain a fourth distance-velocity spectrum, and a measured value on the fourth distance-velocity spectrum corresponding to the first position is extracted, which is denoted as a second measured value.

After obtaining the first measured value and the second measured value, an estimated value of angle of the target may be obtained based on the first measured value and the second measured value. For example, an angle deviation between the direction of the target and the current (digital received) beam sweeping direction may be obtained based on the first measured value and the second measured value, and then the estimated value of angle of the target may be obtained according to the angular deviation. For example, obtaining the angular deviation between the direction of the target and the current (digital received) beam sweeping direction based on the first measured value and the second measured value may comprises: obtaining a result of performing a predetermined operation on the first measured value and the second measured value; obtaining the angular deviation between the direction of the target and the current (digital received) beam sweeping direction according to a pre-established correspondence between the result of the predetermined operation and the angular deviation. According to the embodiment, the predetermined operation may be a division operation, but not limited to this. For example, it may also be a subtraction operation.

For example, a one-to-one correspondence between the quotient resulting from dividing the first measured value by the second measured value and the angular deviation may be established in advance. As an example, the one-to-one correspondence may be expressed by a look-up table, as shown in Table 1.

TABLE 1
Correspondence Table for Obtaining Angular Deviation

| Quotient resulting from dividing first | |
|---|---|
| measured value by second measured value | Angular deviation |
| α₁ | φ₁ |
| α₂ | φ₂ |
| α₃ | φ₃ |
| . . . | . . . |

In the case that the correspondence table is established in advance, the quotient resulting from dividing the first measured value by the second measured value may be calculated, and the angular deviation corresponding to the quotient may be obtained by looking up the correspondences in the above correspondence table.

After obtaining the angular deviation between the direction of the target and the current (digital received) beam sweeping direction, the estimated value of angle of the target may be obtained according to the angular deviation. For example, an initial estimated value of angle of the target may be obtained, and the initial estimated value of angle may be corrected according to the angular deviation to obtain the estimated value of angle of the target. Here, the initial estimated value of angle of the target may be the sweeping angle of the current (digital received) beam, for example, a sweeping angle of a sum beam, and the estimated value of angle of the target may be obtained by adding the initial estimated value of angle with the obtained angular deviation.

In the method of FIG. 6, since the first digital received signal and the second digital received signal are obtained respectively, performing sensing (also referred to as received signal estimation) based on such two digital received signals can achieve more accurate sensing (also referred to as received signal estimation).

FIG. 8 is a flowchart illustrating another method performed by a wireless communication device according to an embodiment of the present disclosure.

Referring to FIG. 8, in step S810, the wireless communication device may obtain a first digital received signal. For example, the first digital received signal may be obtained by performing a first (digital) received beam sweeping, or obtained based on signals received by a plurality of sub-arrays of a receiving antenna panel of the wireless communication device. For example, it is assumed that the time domain received signal within the receiving window is y[n], where n=0, 1, . . . , N_{FFT}−1, N_{FFT} is the number of samples for Fourier Transform, and the vector form of y[n] is

$$y = [ \begin{matrix}y [ 0 ] \\ ⋮ \\ y [ {N}_{FFT} - 1 ]\end{matrix} ]$$

In step S820, the wireless communication device may perform first signal processing on the first digital received signal using a first parameter set to obtain a first residual signal. Specifically, the first parameter set may be preset or higher layer configured, or may be calculated in real time based on the first digital received signal. According to an embodiment of the present disclosure, for example, the first digital received signal may be a sum beam received signal, the first signal processing may be self-interference cancellation, and accordingly, the first parameter set may be the order and channel paths for self-interference cancellation, and the first residual signal may be a signal resulting from performing self-interference cancellation on the first digital received signal. Optionally, the method shown in FIG. 8 may further comprise: performing a first (digital) received beam sweeping and/or performing target detection according to the first residual signal. The specific steps of performing the first (digital) received beam sweeping, self-interference cancellation and target detection have already been described in the method shown in FIG. 6, and will not be detailed here.

In case that a target is detected within the coverage of a certain first digital received beam, the wireless communication device may obtain a second digital received signal in step S830. According to an embodiment of the present disclosure, the second digital received signal may be obtained by performing a second (digital) received beam sweeping, or may be obtained based on signals received by a plurality of sub-arrays of the receiving antenna panel. For example, according to an embodiment of the present disclosure, the first digital received beam may be a sum beam and the second digital received beam may be a differential beam. The beam patterns of the sum beam and the differential beam may be as shown in FIG. 7. In an example that the receiving antenna panel of the wireless communication device is a linear array, the beamforming coefficients used to perform a differential beam sweeping may be as follows:

$$[ 1 , {e}^{\frac{j 2 π sin ( θ ) d}{λ}} , … , {e}^{\frac{j 2 π ( N / 2 - 1 ) sin ( θ ) d}{λ}} , - {e}^{\frac{j 2 π ( N / 2 ) sin ( θ ) d}{λ}} , … , - {e}^{j 2 π ( N - 1 ) sin ( θ ) d / λ} ]$$

Where θ is the beam sweeping angle, d is the spacing between antenna elements, λ is the wavelength, and N is the number of antenna elements. For example, it is assumed that the time domain signal of the differential beam is y_{diff}[n], where n=0, 1, . . . , N_{FFT}−1, N_{FFT} is the number of samples for Fourier Transform, and the vector form of y_{diff}[n] is

$${y}_{diff} = [ \begin{matrix}{y}_{diff} [ 0 ] \\ ⋮ \\ {y}_{diff} [ {N}_{FFT} - 1 ]\end{matrix} ] .$$

In step S840, the wireless communication device may determine a second parameter set based on the first digital received signal and/or the first residual signal and/or the first parameter set as well as the second digital received signal. For example, in case that the first digital received signal is a sum beam signal, the second digital received signal is a differential beam signal, the first signal processing is self-interference cancellation, and the first parameter set contains the order and channel paths for self-interference cancellation, then the second parameter set may also be the order and channel paths for self-interference cancellation.

Specifically, one specific implementation of determining the second parameter set may be to determine a first measured value set related to the first parameter set according to the first digital received signal and/or the first residual signal and/or the first parameter set, and determine the second parameter set according to the first measured value set and the second digital received signal. Still further, one specific implementation of determining the second parameter set according to the first measured value set and the second digital received signal may be to determine a second measured value set according to the first measured value set and the second digital received signal, and to determine the second parameter set according to the second measured value set and the second digital received signal.

For example, when the first digital received beam is a sum beam, the second digital received beam is a differential beam, the first digital received signal is a sum beam signal, the second digital received signal is a differential beam signal, the first signal processing is self-interference cancellation, the first parameter set contains the order and channel paths for self-interference cancellation, and the first residual signal is a sum beam signal after self-interference cancellation, then the first measured value set may include, but is not limited to, an average power value of the sum beam signal, and/or an average power value of the sum beam signal (i.e., first residual signal) after self-interference cancellation, and/or one or more of average power values of components of odd-order such as first-order and/or third-order and/or fifth-order in the first reconstructed signal during self-interference cancellation, and/or the first distance-velocity spectrum. Wherein the first reconstructed signal may be an intermediate result in the process of obtaining the first residual signal by performing the first signal processing on the first digital received signal using the first parameter set. For example, the first reconstructed signal may be a product of the local signal and the channel estimate that corresponds to the order of self-interference cancellation and channel paths of self-interference cancellation corresponding to the first parameter set.

Still further, for example, when the first measured value set contains one or more of the power values of the sum beam signals after self-interference cancellation, and the power values of the components of first-order and/or third-order and/or fifth-order in the first reconstructed signal during self-interference cancellation, one possible implementation of determining the second parameter set according to the first measured value set and the second digital received signal may be to calculate the power value of the differential beam signal, and to compare it with the power values of first-order and/or third-order components and/or fifth-order components in the first reconstructed signal, so as to find the smallest N (N=1, 3, 5) so that the power value of the differential beam signal is greater than the power value of the Nth-order component in the first reconstructed signal, and to determine that the order of self-interference cancellation in the second parameter set is N; and to determine that the order of self-interference cancellation in the second parameter set is 0 (i.e., it is unnecessary to perform self-interference cancellation on the differential beam signal) when the power value of the differential beam signal is not greater than the power value of the components belonging to any order in the first reconstructed signal.

One possible implementation of determining the order N of self-interference cancellation in the second parameter set is given as follows: it is assumed that the order of self-interference cancellation of the sum beam is 5, the number of (channel) paths of self-interference cancellation is L, the time domain convolution matrix of the first-order component corresponding to the sum beam is S₁, and the time domain convolution matrices of the third-order component and the fifth-order component are respectively S₃=S₁⊙|S₁|² and s₅=s₁⊙|S₁|⁴. Then the local signal Xᵢₙᵢₜ of self-interference cancellation is a matrix composed of the first L columns of S₁, the first L columns of S₃ and the first L columns of S₅ in order. The estimated value of the self-interference channel is ĥᵢₙᵢₜ. Then first-order, third-order and fifth-order components in the first reconstructed signal are expressed as y₁=(Xᵢₙᵢₜ)_{1:L} (ĥᵢₙᵢₜ)_{1:L}, y₂=(Xᵢₙᵢₜ)_{L+1:2L} (ĥᵢₙᵢₜ)_{L+1:2L} and y3=(Xᵢₙᵢₜ)_{2L+1:3L}(ĥᵢₙᵢₜ)_{2L+1:3L} respectively. Wherein, (Xᵢₙᵢₜ)_{1:L} represents a matrix composed of the extracted columns 1 to L from Xᵢₙᵢₜ, and (ĥᵢₙᵢₜ)_{1:L} represents a matrix composed of the extracted rows 1 to L from ĥᵢₙᵢₜ. Then the power values of the first-order, third-order and fifth-order components are expressed as

$${P}_{1} = \frac{1}{{N}_{FFT}} \sum {\vert {y}_{1} \vert}^{2} , {P}_{2} = \frac{1}{{N}_{FFT}} \sum {\vert {y}_{2} \vert}^{2} and {P}_{3} = \frac{1}{{N}_{FFT}} \sum {\vert {y}_{3} \vert}^{2}$$

respectively. The power value of the differential beam signal is calculated as

$${P}_{diff} = \frac{1}{{N}_{FFT}} {\sum }_{n = 0}^{{N}_{F F T} - 1} {\vert {y}_{diff} [ n ] \vert}^{2} .$$

For example, when P₃<P_{diff}<P₂, the order of self-interference cancellation of the differential beam is determined as N=3.

For another example, when the first measured values set contains a first distance-velocity spectrum, a second measured values set may be determined according to the first measured values set and the second digital received signal. The second measured values set may include, but is not limited to, a difference between an estimated value of noise floor power in the first distance-velocity spectrum and an estimated value noise floor power in the distance-velocity spectrum corresponding to the second digital received signal (hereinafter referred to as a second distance-velocity spectrum), which is denoted as a first difference value, as well as the highest power value in the first distance-velocity spectrum. For example, the estimated value of noise floor power in the first distance-velocity spectrum may be the average power value of the first distance-velocity spectrum, or may be the average power value of a part of area of the first distance-velocity spectrum where no target is sensed. For example, the estimated value of noise floor power in the second distance-velocity spectrum may be the average power value of the second distance-velocity spectrum, or may be the average power value of a part of area of the second distance-velocity spectrum where no target is sensed. Wherein the second distance-velocity spectrum may be obtained by performing two-dimensional discrete Fourier transform (2D-DFT) on the second digital received signal. Then, one possible implementation of determining the second parameter set according to the second measured value set and the second digital received signal may be to obtain a difference between the highest power value in the first distance-velocity spectrum and the first difference value, which is denoted as a second difference value, and to select the distance coordinates corresponding to the samples in the second distance-velocity spectrum with a power higher than (or equal to) that of the second difference value, as a set of (channel) paths of self-interference cancellation in the second parameter set. That is, for a selected sample, a difference between the power value corresponding to the sample in the second distance-velocity spectrum and the noise floor power value in the second distance-velocity spectrum is greater than or equal to a difference between the maximum power value in the first distance-velocity spectrum and the noise floor power value in the first distance-velocity spectrum.

Considering that the computational complexity of self-interference cancellation increases with the increase of the order, the determination of the second parameter set based on the first digital received signal and/or the first residual signal and/or the first parameter set as well as the second digital received signal has beneficial effects that: a demand for self-interference cancellation of the differential beam can be decided through the intermediate result during the first signal processing, and the order of self-interference cancellation can be decided in real time according to the power of the differential beam, thus reducing the computational complexity.

Unlike a technology of conventional digital domain self-interference cancellation where, in practice, the complex operations involved in a process of self-interference channel estimation that has nothing to do with dynamically receiving signals can be done off-line, and corresponding parameters for self-interference channel estimation can be generated, and the generated parameters can be stored in storage resources of hardware in advance, the embodiment of the present disclosure determines the order for performing self-interference cancellation on the differential beam signal by comparing the power value of the components of the reconstructed signal in the sum beam with the power value of the differential beam signal, determines the order for performing self-interference cancellation on the differential beam signal based on the distance-velocity spectrum of the sum beam signal and the distance-velocity spectrum of the differential beam signal, and thus achieves adjusting the order and channel paths for self-interference cancellation of the differential beam signal according to the actual situation or features of the differential beam signal, so as to meet the actual requirements for self-interference cancellation, obtain a more accurate result of self-interference channel estimation of the differential beam signal, and improve the effect of self-interference cancellation of the differential beam signal. Therefore, a more accurate sensing result can be obtained, when the sum beam signal and the differential beam signal are used for target sensing in the technology of integrated sensing and communications.

In step S850, the wireless communication device may perform second signal processing on the second digital received signal using the second parameter set to obtain a second residual signal. For example, when the second signal processing is self-interference cancellation, and the second parameter set is also the order and channel paths for self-interference cancellation, the second residual signal may be a signal resulting from performing self-interference cancellation on the second digital received signal. Wherein one possible implementation method for self-interference cancellation has been illustrated in the method shown in FIG. 6, and will not be detailed here.

In step S860, the wireless communication device may perform sensing (also referred to as received signal estimation) based on the first residual signal and the second residual signal. Wherein one possible implementation method for sensing (and/or received signal estimation) has been illustrated in the method shown in FIG. 6, and will not be detailed here.

In the method of FIG. 8, since at first the first signal processing is performed on the first digital received signal using the first parameter set to obtain the first residual signal, and then the second parameter set is determined based on the first digital received signal and/or the first residual signal and/or the first parameter set as well as the second digital received signal, determining the second parameter set based on the above method may avoid performing a process of complex signal processing on the second digital received signal, so that more accurate sensing (also referred to as received signal estimation) can be performed with lower computational complexity. That is, the device may avoid performing a process of complex signal processing on the second digital signal.

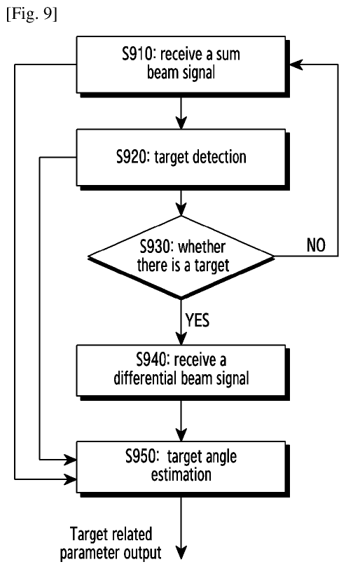

The way in which the wireless communication device of the present disclosure performs sensing (also be referred to as received signal estimation) will be further described with reference to the examples of FIG. 9 to FIG. 12. Wherein taking target detection and angle estimation as an example, the possible implementation of sensing (also referred to as received signal estimation) is described.

FIG. 9 is a flowchart illustrating a method for target detection and angle estimation performed by a wireless communication device according to an embodiment of the present disclosure.

The wireless communication device may transmit a certain sensing signal. Referring to FIG. 9, the wireless communication device may receive a signal using a sum beam in step S910, that is, obtain a sum beam signal. The wireless communication device may perform target detection on the sum beam signal in step S920. The wireless communication device may determine whether there is a target in the current beam in step S930. For example, one implementation of performing target detection on the sum beam signal is to perform 2D-DFT transformation on the sum beam signal to obtain a distance-velocity spectrum of the sum beam signal, in which the horizontal and vertical coordinates of the distance-velocity spectrum are distance and velocity respectively. The higher the measured value (e.g., received power value) of each sample in the distance-velocity spectrum is, the greater the indicated possibility that there is a target here is. Therefore, target detection may be performed according to the third distance-velocity spectrum. In case that it is determined that there is no target, the method switches to another beam direction and repeats the above process. Otherwise, the method proceeds to step S940 in which the wireless communication device receives a differential beam signal, and the wireless communication device performs target angle estimation in step S950. Wherein one specific implementation of target angle estimation is to at first perform 2D-DFT transformation on the differential beam signal to obtain the distance-velocity spectrum of the differential beam signal, and to extract the power value at the distance-velocity coordinates corresponding to a certain target on the distance-velocity spectrum of the sum beam, and denote it as a first measured value, and to extract the power value at the distance-velocity coordinates corresponding to a certain target on the distance-velocity spectrum of the differential beam, and denote it as a second measured value. After obtaining the first measured value and the second measured value, an estimated value of angle of the target may be obtained based on the first measured value and the second measured value. The obtaining of the estimated value of angle of the target based on the first measured value and the second measured value has been illustrated in the corresponding embodiment of FIG. 6.

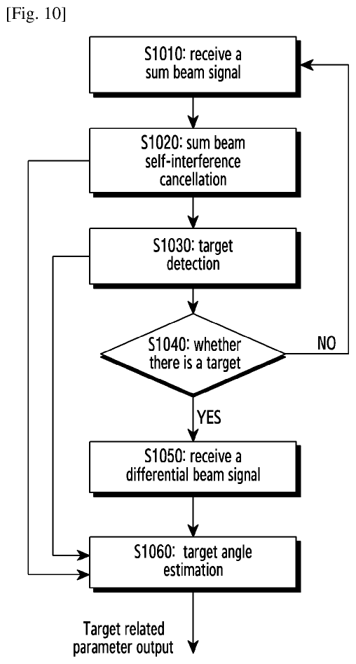

FIG. 10 is a flowchart illustrating a method for target detection and angle estimation performed by a wireless communication device according to an embodiment of the present disclosure.

According to an embodiment, the wireless communication device may transmit a certain sensing signal. Referring to FIG. 10, in step S1010, the wireless communication device receives a signal using a sum beam, that is, obtains a sum beam signal. In step S1020, the wireless communication device performs self-interference cancellation on the sum beam signal to obtain a first residual signal. one possible specific implementation of self-interference cancellation has been illustrated in the corresponding embodiment of FIG. 6. The wireless communication device performs target detection on the first residual signal in step S1030, and determines whether there is a target in the current beam in step S1040. For example, one implementation of performing target detection on the first residual signal is to perform 2D-DFT transformation on the first residual signal to obtain a distance-velocity spectrum of the first residual signal, in which the horizontal and vertical coordinates of the distance-velocity spectrum are distance and velocity respectively. The higher the measured value (e.g., received power value) of each sample in the distance-velocity spectrum is, the greater the indicated possibility that there is a target here is. Therefore, target detection may be performed according to the third distance-velocity spectrum. In case that it is determined that there is no target, the method switches to another beam direction and repeats the above process. Otherwise, the method proceeds to step S1050 in which the wireless communication device receives a differential beam signal. Moreover, in step S1060, the wireless communication device performs target angle estimation. One specific implementation of target angle estimation is to at first perform 2D-DFT transformation on the differential beam signal to obtain a distance-velocity spectrum of the differential beam signal, and to extract the power value at the distance-velocity coordinates corresponding to a certain target on the distance-velocity spectrum of the first residual signal, denote it as a first measured value, and to extract the power value at the distance-velocity coordinates corresponding to a certain target on the distance-velocity spectrum of the differential beam, denote it as a second measured value. After obtaining the first measured value and the second measured value, an estimated value of angle of the target may be obtained based on the first measured value and the second measured value. The obtaining of the estimated value of angle of the target based on the first measured value and the second measured value has been illustrated in the corresponding embodiment of FIG. 6.

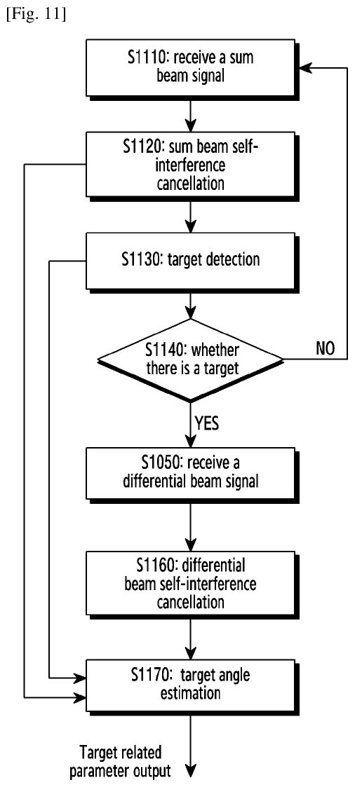

FIG. 11 is a flowchart illustrating a method for target detection and angle estimation performed by a wireless communication device according to an embodiment of the present disclosure.

According to an embodiment, the wireless communication device at first transmits a certain sensing signal. Referring to FIG. 11, in step S1110, the wireless communication device receives a signal using a sum beam, that is, obtains a sum beam signal. In step S1120, the wireless communication device performs self-interference cancellation on the sum beam signal to obtain a first residual signal. One possible implementation of self-interference cancellation has been illustrated in the corresponding embodiment of FIG. 6. In step S1130, the wireless communication device performs target detection on the first residual signal. In step S1140, the wireless communication device determines whether there is a target in the current beam. For example, one implementation of performing target detection on the first residual signal is to perform 2D-DFT transformation on the first residual signal to obtain a distance-velocity spectrum of the first residual signal, wherein the horizontal and vertical coordinates of the distance-velocity spectrum are distance and velocity respectively. The higher the measured value (e.g., received power value) of each sample in the distance-velocity spectrum is, the greater the indicated possibility that there is a target here is. Therefore, target detection may be performed according to the third distance-velocity spectrum. In case that it is determined that there is no target, the method switches to another beam direction and repeats the above process. Otherwise, in step S1150, the wireless communication device receives a differential beam signal, and in step S1160, the wireless communication device performs self-interference cancellation on the differential beam signal to obtain a second residual signal. In step S1170, the wireless communication device performs target angle estimation. One specific implementation of target angle estimation is to at first perform 2D-DFT transformation on the second residual signal to obtain a distance-velocity spectrum of the second residual signal, and to extract the power value at the distance-velocity coordinates corresponding to a certain target on the distance-velocity spectrum of the first residual signal, which is denoted as a first measured value, and to extract the power value at the distance-velocity coordinates corresponding to a certain target on the distance-velocity spectrum of the second residual signal, which is denoted as a second measured value. After obtaining the first measured value and the second measured value, an estimated value of angle of the target may be obtained based on the first measured value and the second measured value. The obtaining of the estimated value of angle of the target based on the first measured value and the second measured value has been illustrated in the corresponding embodiment of FIG. 6.

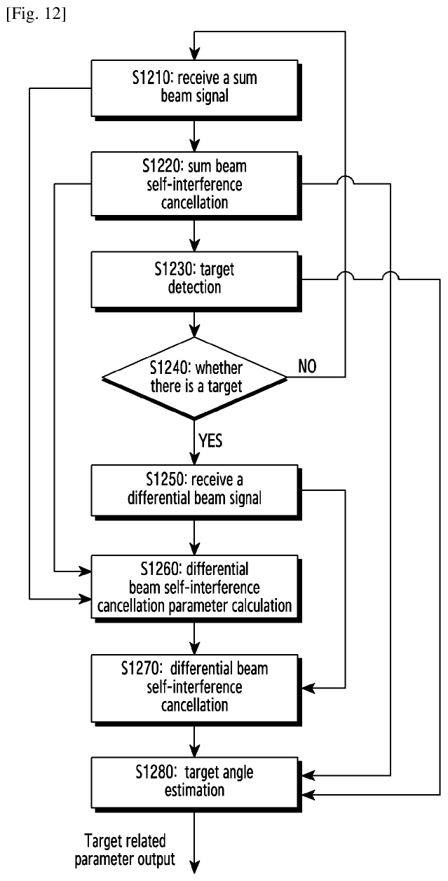

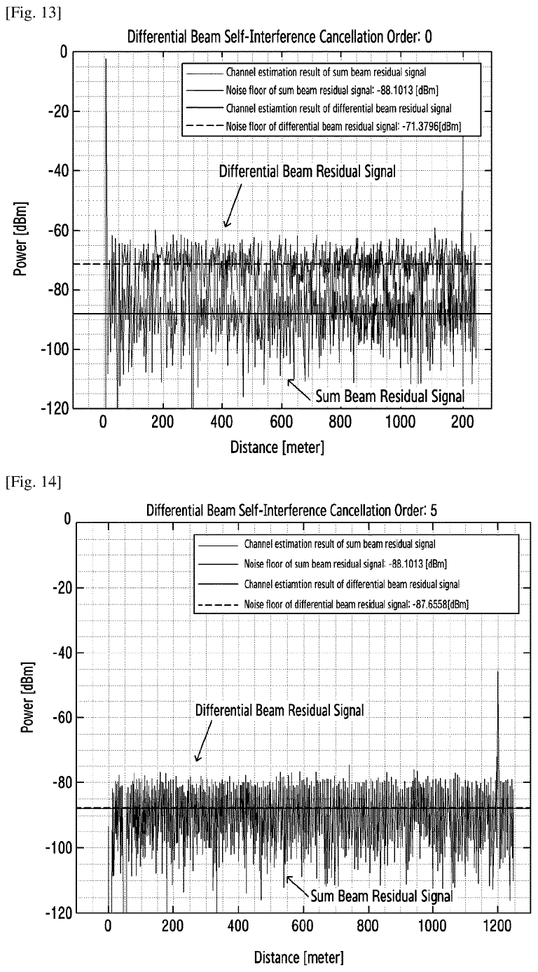

FIG. 12 is a flowchart illustrating a method for target detection and angle estimation performed by a wireless communication device according to an embodiment of the present disclosure.

According to an embodiment, the wireless communication device at first transmits a certain sensing signal. Referring to FIG. 12, in step S1210, the wireless communication device receives a signal using a sum beam, that is, obtains a sum beam signal. In step S1220, the wireless communication device performs self-interference cancellation on the beam signal to obtain a first residual signal, wherein one possible specific implementation of self-interference cancellation has been illustrated in the corresponding embodiment of FIG. 6. In step S1230, the wireless communication device performs target detection on the first residual signal, and in step S1240, the wireless communication device determines whether there is a target in the current beam. For example, one implementation of performing target detection on the first residual signal is to perform 2D-DFT transformation on the first residual signal to obtain a distance-velocity spectrum of the first residual signal, wherein the horizontal and vertical coordinates of the distance-velocity spectrum are distance and velocity respectively. The higher the measured value (e.g., received power value) of each sample in the distance-velocity spectrum is, the greater the indicated possibility that there is a target here is. Therefore, target detection may be performed according to the third distance-velocity spectrum. In case that it is determined that there is no target, the method switches to another beam direction and repeats the above process. Otherwise, in step S1250, the wireless communication device receives a differential beam signal, and in step S1260, the wireless communication device determines parameters for self-interference cancellation of differential beam according to one or more of the sum beam signal, the first residual signal, and the parameters for self-interference cancellation of beams, as well as the differential beam signal. The parameters for self-interference cancellation of differential beam may include channel paths of self-interference cancellation of differential beam and the order of self-interference cancellation of differential beam. The two implementations of determining the parameters for self-interference cancellation of differential beam according to one or more of the sum beam signal, the first residual signal, and the parameters for self-interference cancellation of the sum beam, as well as the differential beam signal, have been described in the corresponding embodiment of FIG. 8. After obtaining the parameters for self-interference cancellation of differential beam, the wireless communication device performs self-interference cancellation on the differential beam signal to obtain a second residual signal in step S1270, and performs target angle estimation in step S1280. One specific implementation of target angle estimation is to at first perform 2D-DFT transformation on the second residual signal to obtain a distance-velocity spectrum of the second residual signal, and to extract the power value at the distance-velocity coordinates corresponding to a certain target on the distance-velocity spectrum of the first residual signal, which is denoted as a first measured value, and to extract the power value at the distance-velocity coordinates corresponding to a certain target on the distance-velocity spectrum of the second residual signal, which is denoted as a second measured value. After obtaining the first measured value and the second measured value, an estimated value of angle of the target may be obtained based on the first measured value and the second measured value. The obtaining the estimated value of angle of the target based on the first measured value and the second measured value has been illustrated in the corresponding embodiment of FIG. 6.

FIG. 13 and FIG. 14 illustrate example implementation results of a method according to an embodiment of the present disclosure. There are two targets set in the environment, the distance between target 1 and the sensing node (wireless communication device) is set as R₁=50 m, and the scattering coefficient is set as S₁=1 [m²]; the distance between target 2 and the sensing node is set as R₂=1200 m, the scattering coefficient is set as S₂=1 [m²], and the horizontal angle is set as 80 degrees. The pulse signal selected by the sensing node may be a downlink demodulation reference signal (DMRS) signal. Detection and angle estimation is performed on target 2. Wherein the sum beam employs a fifth-order self-interference cancellation, and the result of target detection without performing self-interference cancellation according to an embodiment of the present disclosure is shown in FIG. 13, and the result of target detection with self-interference cancellation performed according to an embodiment of the present disclosure is shown in FIG. 14, wherein the (channel) paths of self-interference cancellation of the differential beam may be calculated according to the method described above in connection with FIG. 8. As shown in FIG. 13, when self-interference cancellation is not performed on the differential beam, an estimated value of angle corresponding to target 2 is 80.0801 degrees, and an estimated error is 0.0801 degrees; while as shown in FIG. 14, when the parameters for self-interference cancellation are calculated for the differential beam according to the method in the present disclosure, self-interference cancellation is performed, an estimated value of angle is 79.9732 degrees, and an estimated error is 0.0268 degrees. It can be seen that the digital domain interference cancellation method proposed in the present disclosure can improve the accuracy of target angle estimation.

According to another embodiment of the present disclosure, a self-interference cancellation method is provided, which supports the sensing node to dynamically calculate parameters (e.g., indexes of channel paths) for self-interference cancellation. This method can be used for self-interference cancellation of any echo signal, for example, self-interference cancellation of a sum beam and/or self-interference cancellation of a differential beam. One possible implementation is that the method for calculating parameters for self-interference cancellation in this embodiment can be used in step S620, or step S640, or both steps S620 and S640 of the corresponding method in FIG. 6. For example, the method for calculating parameters for self-interference cancellation in this embodiment can be used in step S820, or step S850, or both steps S820 and S850 of the method corresponding to FIG. 8. For example, the part of calculating parameters for self-interference cancellation in this method can be used to replace step S840 of the method corresponding to FIG. 8.

In the ISAC system, the sensing node needs to transmit a sensing signal and receive an echo of the sensing signal. As mentioned above, the echo received by the sensing node contains the electromagnetic wave leaked from the transmitting antenna panel and the electromagnetic wave received by the receiving antenna panel resulting from the sensing signal being reflected by the target in the environment. The closer the target is and/or the larger the RCS (radar cross section, i.e. a terminology in the field of radar, which is a physical quantity used to measure the intensity of the echo resulting from the target under radar wave irradiation) of the target is, the higher the power of the electromagnetic wave received by the receiving antenna panel is.

Moreover, since in the process of transmitting the sensing signal, the magnitude of part of signals may exceed the linear operating area of the power amplifier, the transmitted signal contains not only a linear component of the sensing signal (i.e., the sensing signal that the sensing node wants to send itself), but also a nonlinear component of the sensing signal introduced by the power amplifier. Wherein the power of the nonlinear component is often lower than that of the linear component.

Therefore, when there are both near and far objects in the sensing environment, it may happen that the electromagnetic wave reflected by the near target has a higher power, while the electromagnetic wave reflected by the far target has a lower power. The electromagnetic wave reflected by the near target will drown the electromagnetic wave reflected by the far target, that is, after channel estimation of the received signal, the main lobe corresponding to the far target will be drowned by the side lobe of the power of the near target in the “distance spectrum”, i.e., a near-far effect will occur, wherein the power of the side lobe is usually lower than that of its corresponding main lobe; or alternatively, the main lobe corresponding to the far target will be drowned by the nonlinear component in the electromagnetic wave reflected by the near target. In the above example, by cancelling the electromagnetic wave leaked by the transmitting panel and/or the echo from the near target in the received signal, i.e., by means of self-interference cancellation, for example, cancelling the self-interference in the received signal in digital domain, the main lobe corresponding to the far target in the distance spectrum can be exposed, and the probability of successful detection of the far target can be increased.

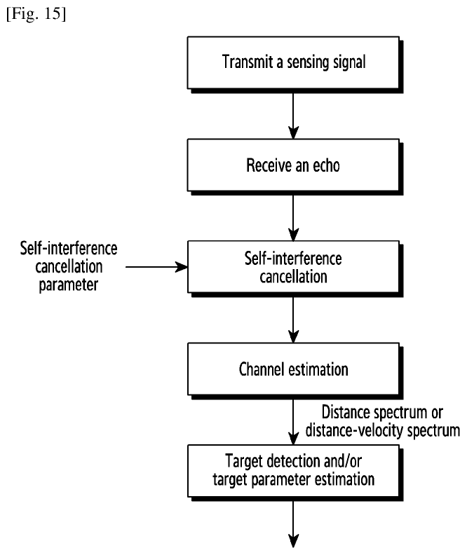

Generally, as shown in FIG. 15, before performing self-interference cancellation, the sensing node needs to at first determine the parameters for self-interference cancellation, for example, the channel paths in self-interference cancellation (more specifically, it may be the indexes of channel paths) and/or the order of self-interference cancellation and/or the order corresponding to the channel paths of self-interference cancellation. It should be noted that in various methods of self-interference cancellation mentioned in the present disclosure, the order of self-interference cancellation is a concept for each channel path. Different channel paths can correspond to different orders of self-interference cancellation, or different channel paths can correspond to the same order of self-interference cancellation. When all channel paths of self-interference cancellation correspond to the same order of self-interference cancelled, “order of self-interference cancelled” means the order of self-interference cancellation corresponding to all channel paths of self-interference cancellation. Considering that the ISAC system needs to sense the environment, therefore, in the ISAC system, the self-interference signal may be defined as the electromagnetic wave leaked from the transmitting antenna panel, and the part with higher power of the electromagnetic wave received by the receiving antenna panel resulting from the sensing signal being reflected by the target in the environment. In this case, the above-mentioned self-interference cancellation method using preset parameters cannot adaptively adjust the parameters according to the received signal, so this may cause the sensing node to not completely cancel the part defined as self-interference in the received signal, thus increasing the missed detection probability of far targets and affecting the function of the sensing system.

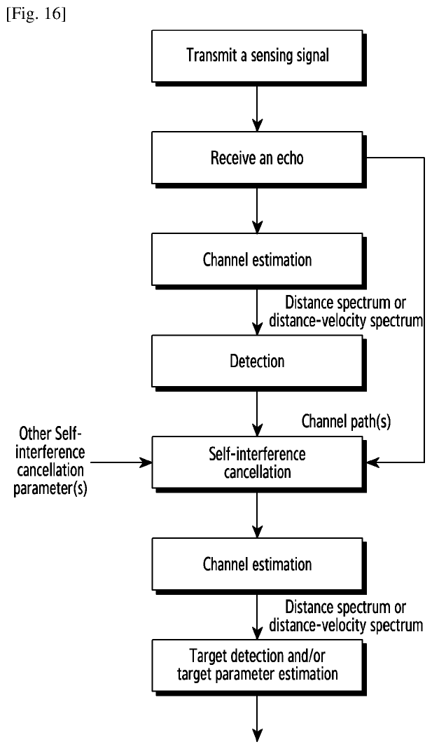

Base on the above reasons, a self-interference cancellation process as shown in FIG. 16 is considered. Firstly, the sensing node transmits a sensing signal and receives an echo corresponding to the sensing signal, performs channel estimation on the echo to obtain a power spectrum, such as a distance spectrum or a distance-velocity spectrum, and then performs the detection algorithm, for example, set a certain power threshold and take the channel paths corresponding to samples above the threshold in the power spectrum as the output of the detection algorithm. The output of the detection algorithm is used as part of the input parameters of the self-interference cancellation algorithm, for example, the indexes of channel paths of self-interference cancellation. For example, one or more power thresholds are set, the power corresponding to each channel path in the power spectrum is compared with the above one or more thresholds, and an order of self-interference cancellation corresponding to each channel path is determined based on a result of the comparison. Preferably, the greater the power value of a certain channel path on the power spectrum is, the higher the corresponding order of self-interference cancellation is. Such a design has beneficial effects that, the accuracy of self-interference channel estimation is improved, so as to obtain a more accurate signal after self-interference cancellation. One possible implementation is to set threshold A and threshold B, wherein the value of threshold A is smaller than that of threshold B, to set the order of self-interference cancellation of channel paths with power(s) higher than threshold B in the power spectrum to fifth-order, to set the order of self-interference cancellation of channel paths with power(s) between threshold A and threshold B in the power spectrum to third-order, and set the order of self-interference cancellation of channel paths with power(s) lower than threshold A in the power spectrum to zeroth-order or first-order. However, the above set orders are all exemplary, and other settings are also possible.

Another feasible self-interference cancellation process is that: the sensing node repeats a self-interference cancellation process A and calculates the power of the reconstructed signal of self-interference. when the power of the reconstructed signal of self-interference is lower than a certain threshold, the sensing node performs a self-interference cancellation process B, or otherwise, continuously performs the self-interference cancellation process A and perform power calculation and threshold determination on the reconstructed signal. The self-interference cancellation process A and the self-interference cancellation process B among the self-interference cancellation processes that are periodically performed and switched may be self-interference cancellation processes using one or more of the methods for self-interference cancellation described in the present disclosure.

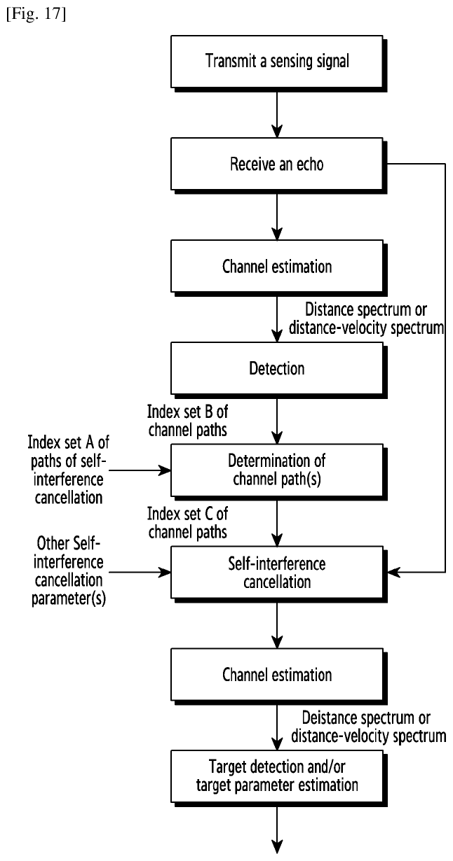

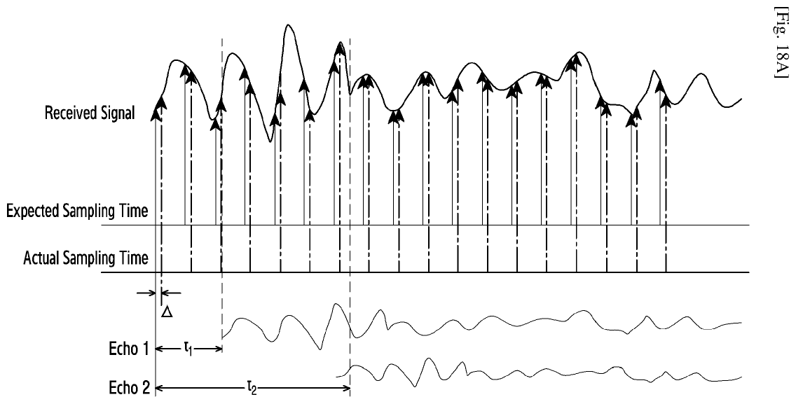

FIG. 17 is another feasible self-interference cancellation process, which adds a method for determining an index set of channel paths of self-interference cancellation to the corresponding self-interference cancellation process of FIG. 16.

In the process of transmitting a single sensing signal and receiving an echo by the sensing node, the electromagnetic wave leaked from the transmitting antenna panel and received by the receiving panel may be considered as the transmitting signal having experienced a certain random delay or a sum of multiple random delays. When the physical distance between the transmitting antenna panel and the receiving antenna panel is relatively close, one or more of the above delays are often relatively small, for example, all less than T. Therefore, during self-interference cancellation, it is necessary to only delete the corresponding channel paths within time T. That is, since the delay and the distance are in one-to-one correspondence, when self-interference is defined as the corresponding echo at a delay of 0≤t≤T, where the delay T corresponds to the L-th channel path (which can also be referred to as channel tap) of the channel, a self-interference processing method is to perform self-interference cancellation on the channel path with the index of 0≤l≤L. Similarly, in the process where the sensing node transmits sensing signals for multiple times and receives echoes, the self-interference cancellation algorithm performs self-interference cancellation on the channel path with the index of 0≤l≤L one by one for individual echoes. Therefore, another feasible process for self-interference cancellation is shown in FIG. 17. During determining indexes of channel paths of self-interference cancellation, an index set A of channel paths of self-interference cancellation is defined at first, the output of detection algorithm is an index set B of channel paths of self-interference cancellation, and then the above sets A and B are input into a function for “determination of channel paths”, and an index set C of channel paths of self-interference cancellation is output. For example, index set C may be a union of index set A and index set B. At this time, the number of channel paths of self-interference cancellation increases, the self-interference component in the output signal of self-interference cancellation decreases, and the detection probability of the sensing system increases. Alternatively, index set C may be an intersection of index set A and index set B. At this time, the range of channels of self-interference cancellation decreases, and the computational complexity of self-interference cancellation correspondingly decreases.

Wherein the index set A of channel paths of self-interference cancellation may be either preset, or configured by the parent node of the device. For example, if the device of integrated sensing and communications is a terminal, then the set A may be preset, configured through Downlink Control Information (DCI) by the base station accessed by it, configured by Media Access Control (MAC) signaling, or configured by high-layer signaling (e.g, radio resource control (RRC) signaling).

In the method of this embodiment, the index of the channel path of self-interference cancellation is dynamically adjusted according to the received signal to obtain a more accurate result of self-interference cancellation, thereby improving the target detection probability of the sensing system.

According to another embodiment of the present disclosure, another self-interference cancellation method is provided, in which a self-interference channel corresponding to a non-sampling time is estimated by calculating a local signal corresponding to the non-sampling time, so as to obtain more accurate self-interference signal reconstruction results and self-interference cancellation results, thereby improving the target detection probability of the sensing system. This method may be used for self-interference cancellation of any echo signal, for example, self-interference cancellation of sum beam and/or self-interference cancellation of differential beam. One possible implementation is that the method for calculating a local signal corresponding to a non-sampling time in this embodiment may be used in step S620, or step S640, or both steps S620 and S640 of the corresponding method in FIG. 6. Similarly, the method for calculating a local signal corresponding to a non-sampling time in this embodiment may be used in step S820, or step S850, or both steps S820 and S850 of the method corresponding to FIG. 8. Similarly, the parameter calculation part of self-interference cancellation in this method may be used to replace step S840 of the corresponding method in FIG. 8.

In the present disclosure, “sampling time” may represent an expected sampling time at the receiving end, that is, the sensing node at first transmits a certain sensing signal, and the receiving end of the sensing node receives the signal, including receiving an analog signal, and then the sensing node samples the analog signal at the expected sampling time at the receiving end to obtain a digital signal. The expected sampling time is the sampling time corresponding to a digital domain expression of the transmitted sensing signal. “Non-sampling time” represents any time instant that differs from the sampling time.

In various embodiments, the sampling time may include at least one of a sampling starting time and a latest sampling time before a non-sampling time. In the ISAC system, a possible sensing method is that the sensing node transmits and receives on its own, that is, it transmits a sensing signal and receives an echo signal corresponding to the signal. Generally, during self-interference cancellation, the sensing signal transmitted by the sensing node is used to calculate the local signal for self-interference cancellation. For example, when the (baseband) sensing signal transmitted by the sensing node is s[n] (n=0, 1, . . . , N_{FFT}−1), in general, this signal is also used as the local signal for self-interference cancellation. For example, for the self-interference cancellation of 0th path, the local signal may be

$${s}_{SIC} ( 0 ) = [ \begin{matrix}s [ 0 ] \\ s [ 1 ] \\ ⋮ \\ s [ {N}_{FFT} ‐ 1 ]\end{matrix} ] ;$$

for the self-interference cancellation of the first path, the local signal may be

$${s}_{SIC} ( 1 ) = [ \begin{matrix}s [ 1 ] \\ s [ 2 ] \\ ⋮ \\ s [ {N}_{FFT} ‐ 1 ] \\ s [ 0 ]\end{matrix} ] .$$

it can be seen that, s_{SIC} (1) is the cyclic shift of s_{SIC} (0). Similarly, for the self-interference cancellation of the k-th path, the local signal may be

$${s}_{SIC} ( k ) = [ \begin{matrix}s [ k ] \\ s [ k + 1 ] \\ ⋮ \\ s [ {N}_{FFT} - 1 ] \\ s [ 0 ] \\ ⋮ \\ s [ k - 1 ]\end{matrix} ] ,$$

that is, the local signals for self-interference cancellation corresponding to different channel paths may be obtained, by performing cyclic shifting on the transmitted signal.

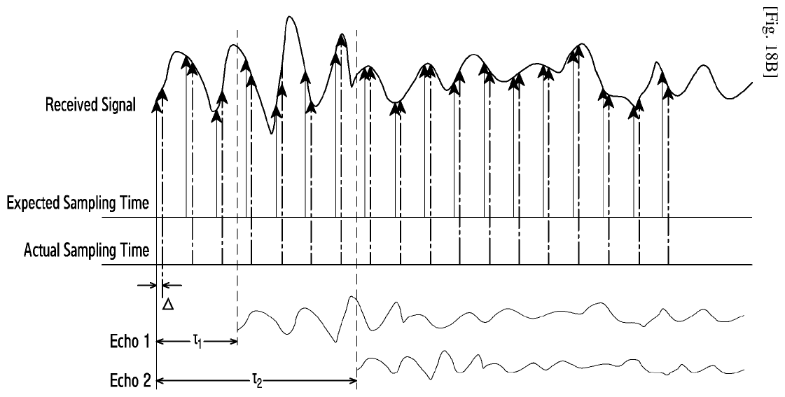

Considering the sensing environment and sampling situation as shown in FIG. 18A, in which there is a certain fixed deviation Δ, which is referred to as an overall fractional time delay, between the expected sampling time and the actual sampling time of the sensing node due to the timing error of the receiver. The arrival times of echo 1 and echo 2 are just aligned with the actual sampling time of the receiver. At this time, the self-interference channels corresponding to echo 1 and echo 2 may be accurately estimated by the above local signal construction method, that is, constructing a local signal of self-interference cancellation by performing cyclical shifting on the transmitted signal s[n] (n=0, 1, . . . , N_{FFT}−1). However, in the actual sensing environment, as shown in FIG. 18B, the time when the echo arrives at the receiving antenna panel is not always aligned with the actual sampling time of the receiver. For example, both the arrival times of echo 1 and echo 2 are between the actual sampling times of the receiver (i.e., between two adjacent samples). That is, between the echoes corresponding to different targets and the actual sampling time of the receiver, there will be an exclusive fractional multiple delay corresponding to the target distance. In this case, by performing cyclical shifting on the transmitted signal s[n] (n=0, 1, . . . , N_{FFT}−1) to construct the local signal for self-interference cancellation, only the self-interference channel of the channel path corresponding to the sample near the actual arrival time of the echo can be estimated, but the self-interference channels corresponding to the echoes of different targets cannot be accurately estimated.

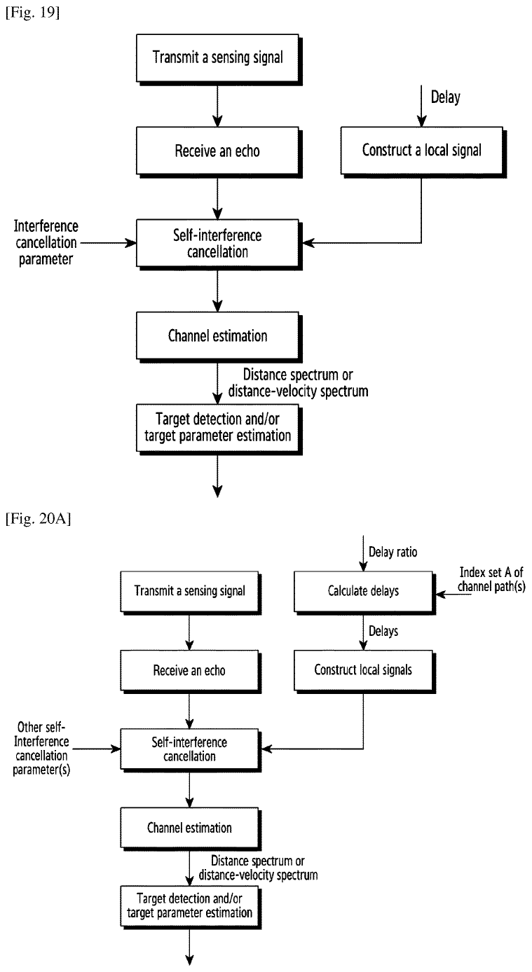

FIG. 19 is another feasible self-interference cancellation method in which given one or more delays, a local signal corresponding to the above one or more delays is constructed according to the delays, then a self-interference channel of the channel path corresponding to the one or more delays is estimated according to the above local signals, then a self-interference signal is reconstructed according to an estimated value of the self-interference channel, and then self-interference cancellation is performed on the received signal.

According to an embodiment, self-interference cancellation corresponding to FIG. 19 will be introduced below. Given one or more delays, for example, the preset multiple delays may be τ₀, τ₁, . . . τ_{N-1}, wherein when N=1, the multiple delays become one delay. One possible implementation of constructing a local signal according to the delay is that, taking τᵢ as an example, where i=0, 1, . . . , N−1, the (baseband) sensing signal transmitted by the sensing node is known as s[n] (n=0, 1, . . . , N_{FFT}−1), which can be written in the form of vector as

$$s = [ \begin{matrix}s [ 0 ] \\ s [ 1 ] \\ ⋮ \\ s [ {N}_{FFT} ‐ 1 ]\end{matrix} ] ,$$

then the method for generating the local signal corresponding to the delay τᵢ is as follows:

1) First, finding the frequency domain signal corresponding to the baseband signal:

$${s}_{F D} = \frac{F F T ( s )}{{N}_{FFT}} ,$$

where FFT(s) represents the Fast Fourier transform (FFT) being performed on the vector s. It should be noted that the FFT here can also be replaced by DFT. s_{FD} is a vector with a length of N_{FFT}, i.e., the frequency domain signal corresponding to the baseband signal.

2) Adding a linear phase rotation to the frequency domain signal:

$${\overline{s}}_{FD} = {s}_{FD} ⊙ [ \begin{matrix}{e}^{j 2 π ( - \frac{{N}_{FFT}}{2} ) {N}_{FFT} {τ}_{i}} \\ {e}^{j 2 π ( - \frac{{N}_{FFT}}{2} + 1 ) {N}_{FFT} {τ}_{i}} \\ \\ {e}^{j 2 π ( \frac{{N}_{FFT}}{2} - 1 ) {N}_{FFT} {τ}_{i}}\end{matrix} ]$$

wherein the operation ⊙ represents an element-wise multiplication of the two physical quantities therebefore and thereafter.

3) Transforming the frequency domain signal with linear phase rotation into time domain:

$$\text{?} = {N}_{FFT} . IFFT ( {\overline{s}}_{FD} ) ,$$

$$\text{?} \text{indicates text missing or illegible when filed}$$

where IFFT(s̅_{FD}) represents the inverse fast Fourier transform (IFFT) performed on the vector s̅_{FD}. Similarly, the IFFT here can also be replaced by IDFT.

$$\text{?}$$

$$\text{?} \text{indicates text missing or illegible when filed}$$

is the local signal corresponding to the delays τᵢ.

After calculating the local signals corresponding to multiple delays τ₀, τ₁, . . . τ_{N-1}, the first-order local signal

$${S}_{1} = [ \begin{matrix}{s}_{{τ}_{0}}^{local} & {s}_{{τ}_{1}}^{local} & … & {s}_{{τ}_{N - 1}}^{local}\end{matrix} ]$$

for estimating the self-interference channel is calculated. Optionally, when the order of self-interference cancellation is greater than one, the third-order and fifth-order local signals for estimating the self-interference channel are S₃=S₁⊙|S₁|² and S₅=S₁⊙|S₁|⁴ respectively, where |·|² and |·|⁴ respectively represent element-wise square and fourth power of absolute values, ⊙ represents an element-wise multiplication of a matrix, and both operation priorities of |·|² and |·|⁴ are higher than that of ⊙. Then the local signal for estimating the self-interference channel may be: Xᵢₙᵢₜ=S₁, when the order of self-interference cancellation is 1; Xᵢₙᵢₜ=[S₁S₃], when the order of self-interference cancellation is 3; Xᵢₙᵢₜ=[S₁S₃S₅], when the order of self-interference cancellation is 5. Similarly, when the order of self-interference cancellation is higher, the local signal may be constructed in a similar method. One possible implementation of calculating the initial self-interference channel estimate ĥᵢₙᵢₜ is as follows:

$${\hat{h}}_{init} = {( {X}_{init}^{H} {X}_{init} + λ I )}^{- 1} {X}_{i n i t}^{H} y$$

Where λ may be a preset value, such as a very small non-negative number, e.g, 10⁻¹⁰, 10⁻⁵, 10⁻¹, etc., and the upper corner symbol H indicates Hermite transposition, I is an identity matrix. The first reconstructed signal after self-interference cancellation is y_{recon1}=xᵢₙᵢₜĥᵢₙᵢₜ, and the first reconstructed signal represents the self-interference on the wireless communication device caused by the sensing signal transmitted by the wireless communication device, and is a self-interference signal. The residual signal after self-interference cancellation (i.e., the first residual signal) may be yᵣₑₛ₁=y−y_{recon1}. The first residual signal represents a signal resulting from cancelling the self-interference on the wireless communication device caused by the sensing signal transmitted by the wireless communication device from the first digital received signal. That is, the first residual signal represents a signal resulting from performing self-interference cancellation on the signal received by the wireless communication device.

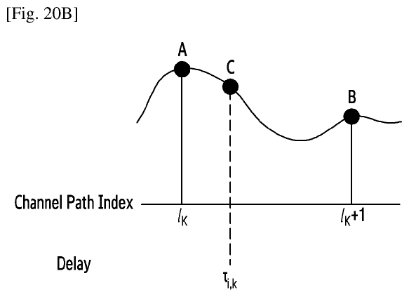

FIG. 20A is another feasible self-interference cancellation method in which given one or more delay ratio parameters and a certain index set of channel paths (e.g., index set A of channel paths), one or more delays corresponding to each element in this set are calculated, then local signals corresponding to the one or more delays are constructed according to the delays, and self-interference channel(s) of channel path(s) corresponding to the one or more delays are estimated according to the above local signals, then a self-interference signal is reconstructed according to estimated values of the self-interference channel, and self-interference cancellation is performed on the received signal.

A possible implementation of self-interference cancellation corresponding to FIG. 20A will be introduced below. Given one or more delay ratio parameters, for example, a plurality of preset delay ratio parameters may be \tilde{τ}₀, \tilde{τ}₁, . . . \tilde{τ}_{N-1}, wherein when N=1, the plurality of delay ratio parameters become one delay ratio parameter. Optionally, the delay ratio parameter may be a number between 0 and 1, for example, 0≤\tilde{τ}ᵢ<1. A given index set of channel paths may be {l₀, l₁, . . . l_{L-1}}, then for a certain element in the index set of channel paths, like lₖ, the delay calculated according to some given delay ratio parameter \tilde{τ}ᵢ is:

$${τ}_{i , k} = \frac{{l}_{k} + {\tilde{τ}}_{i}}{2 \cdot {F}_{s}} ,$$

where F_{S} is the sampling rate of the signal. As shown in FIG. 20B, point A and point B are two adjacent sampling points, and their corresponding indexes of paths are respectively l^{k} and lₖ+1. Whereas during estimating the self-interference channel, it is required to estimate the self-interference channel corresponding to point C, wherein the delay ratio parameter represents a quotient of a time difference (or distance difference) between the sampling points A and C and a time difference (or distance difference) between point A and point B. Then, as shown in FIG. 20B, the physical meaning of τ_{i,k} is the delay corresponding to the number lₖ of channel paths under the delay ratio parameter \tilde{τ}ᵢ, i.e., the delay that corresponds to the delay corresponding to the number lₖ of channel paths plus the delay corresponding to the delay ratio parameter \tilde{τ}ᵢ. After one or more delays corresponding to each element in a given index set of channel paths are obtained by means of the above method, local signals may be constructed according to the delays, and self-interference channel estimation and subsequent self-interference cancellation are performed. The steps of self-interference cancellation have been given above, and will not be detailed here.

It should be noted that each index of a channel path (i.e., an element in the index set of channel paths) may correspond to one or more delay ratios, and the delay ratios corresponding to different indexes of channel paths may be the same or different. The self-interference cancellation operation in which the delay ratios corresponding to different indexes of channel paths are the same is referred to as uniform self-interference cancellation, and the self-interference cancellation operation in which the delay ratios corresponding to different indexes of channel paths are different is referred to as non-uniform self-interference cancellation.

Alternatively, when the sensing node performs uniform self-interference cancellation, and there is more than one element in the index set of channel paths, another method for calculating the local signal is to calculate, for a certain element in the given index set of channel paths, the local signal under one or more delay ratio parameters corresponding to the element, and to obtain the local signal under one or more delay ratio parameters corresponding to other elements in the given index set of channel paths by means of cyclic shift. The beneficial effect of doing this is to reduce the computational complexity when calculating the local signals.

For example, when the given delay ratio parameter is 0.5, and the elements in the given index set of channel paths are 0 and 1, and the (baseband (BB)) sensing signal transmitted by the sensing node is known as s[n] (n=0, 1, . . . , N_{FFT}−1), which can be written in the form of vector as

$$s = [ \begin{matrix}s [ 0 ] \\ s [ 1 ] \\ ⋮ \\ s [ {N}_{FFT} , - 1 ]\end{matrix} ]$$

then the local signals

$${s}_{SIC} ( 0 ) = [ \begin{matrix}s [ 0 ] \\ s [ 1 ] \\ ⋮ \\ s [ {N}_{FFT} , - 1 ]\end{matrix} ] and [ \begin{matrix}s [ 1 ] \\ s [ 2 ] \\ ⋮ \\ s [ {N}_{FFT} , - 1 ] \\ s [ 0 ]\end{matrix} ]$$

corresponding to the elements in the index set of channel paths (i.e. the 0-th path and the first path) may be obtained according to the construction method of local signals of self-interference cancellation (i.e., the cyclic shift method). Considering that the delay ratio parameters corresponding to all the elements in the index set of channel paths are the same, which are all 0.5 in this example, firstly, the local signal corresponding to the first element (the 0th path) in the index set of channel paths when the delay ratio parameter is 0.5 is calculated according to the steps of the corresponding embodiment in FIG. 19, which is denoted as

$${s}_{SIC} ( 0 , 0.5 ) = [ \begin{matrix}{s}^{′} [ 0 ] \\ {s}^{′} [ 1 ] \\ ⋮ \\ {s}^{′} [ {N}_{FFT} - 1 ]\end{matrix} ] ,$$

then the local signal corresponding to the second element (the 1st path) in the index set of channel paths when the delay ratio parameter is 0.5 may be obtained by performing cyclic shift on s_{SIC}(0,0.5), i.e.,

$${s}_{SIC} ( 1 , 0.5 ) = [ \begin{matrix}{s}^{′} [ 1 ] \\ ⋮ \\ {s}^{′} [ {N}_{FFT} - 1 ] \\ {s}^{′} [ 0 ]\end{matrix} ] .$$

The first-order local signal for estimating the self-interference channel is calculated as s₁=[s_{SIC}(0) s_{SIC}(0,0.5) s_{SIC}(1) s_{SIC}(1,0.5)]. It should be noted that the positions of each column of elements in the first-order local signal Sᵢ may be exchanged.

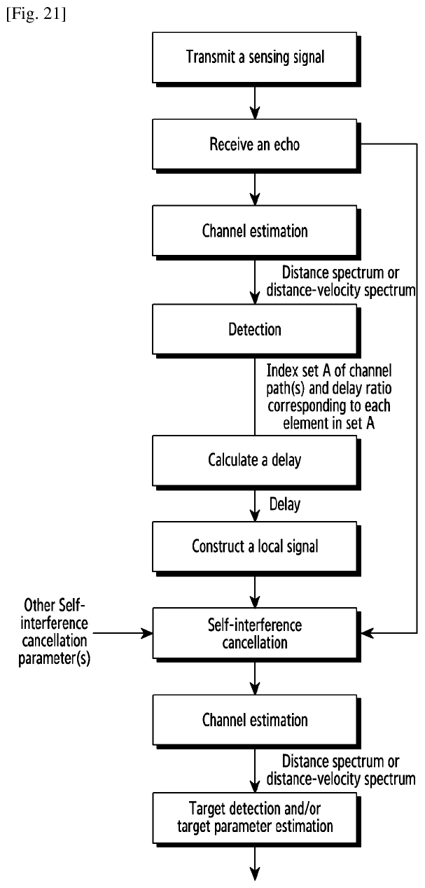

FIG. 21 is another feasible self-interference cancellation method in which, the sensing node transmits a sensing signal and receives an echo, performs channel estimation on the echo to obtain a corresponding distance spectrum or distance-velocity spectrum, obtains an index set A of channel paths and delay ratio parameters corresponding to respective elements in set A through detection algorithm, calculates a delay and constructs a corresponding local signal, and performs self-interference cancellation.

For example, one possible implementation of obtaining an index set A of channel paths and delay ratio parameters corresponding to respective elements in set A through detection algorithm is to determine one or more thresholds, and determine the index set A of the channel paths and delay ratio parameters corresponding to respective elements in set A through detection algorithm according to the relationship between the power value of the distance spectrum or the distance-velocity spectrum corresponding to the channel estimation result of the echo and one or more threshold values. For example, one possible implementation of determining threshold values is to determine one or more thresholds by estimating the noise floor and then adding a corresponding empirical value to the noise floor power. For example, in case that the estimated power of the noise floor is −70 dBm, then one or more thresholds are determined with an empirical value of 40 dB, and the thresholds may be {d₁=−30 dBm, d₂=10 dBm}. One possible implementation of determining the index set A of the channel paths and delay ratio parameters corresponding to respective elements in set A is that, when the power value on the distance spectrum or the distance-velocity spectrum corresponding to a certain index of a channel path, e.g., the lₖ-th path, is higher than a certain threshold, or between two thresholds, the set of delay ratio parameters corresponding to the index of the channel path is determined as Ψₖ. For example, in the above example, in the case that the threshold is set as {d₁=−30 dBm, d₂=10 dBm}: when the power d of a certain path satisfies d₁≤d<d₂, the corresponding delay ratio parameter of the indexes of the channel paths is 0.5, and when the power d of a certain path satisfies d≥d₂, the corresponding delay ratio parameters of the indexes of the channel paths are 0.25, 0.5 and 0.75. Such design has beneficial effects of improving the granularity of self-interference channel estimation near the channel path corresponding to the higher power of the echo, and to obtain more accurate self-interference channel estimation results and more accurate self-interference cancellation results.

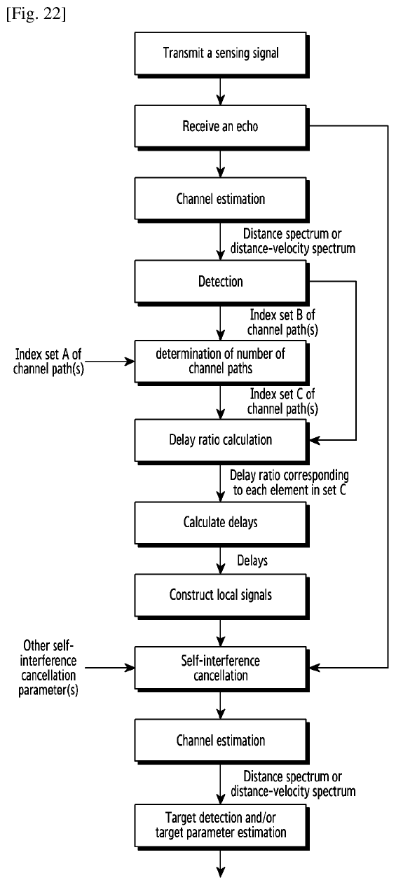

FIG. 22 is another feasible self-interference cancellation method in which the sensing node transmits a sensing signal and receives an echo, performs channel estimation on the echo to obtain a corresponding power spectrum, such as a distance spectrum or a distance-velocity spectrum, obtains an index set B of channel paths through a detection algorithm, then determines an index set C of channel paths according to a predefined or preconfigured index set A of channel paths and the index set B of channel paths, then determines one or more delay ratio parameters corresponding to the elements in the set C according to the index set C of channel paths and the distance spectrum or the distance-velocity spectrum, determines delays according to the index set C of channel paths and the delay ratio parameters, and constructs a corresponding local signal, and then performs self-interference cancellation.

Wherein the index set A of channel paths of self-interference cancellation may be either preset, or configured by the parent node of the device. For example, in case that the device of integrated sensing and communications is a terminal, the set A may be preset, may be configured by the accessed base station through DCI, may be configured by MAC signaling, or may be configured by higher-layer signaling (e.g., RRC signaling).

One possible implementation of the self-interference cancellation process corresponding to FIG. 22 is given below in which the sensing node transmits a sensing signal and receives an echo, performs channel estimation on the echo, and obtains a corresponding power spectrum, such as a distance spectrum or a distance-velocity spectrum. Parameters for self-interference cancellation are determined based on the power spectrum, for example, a detection algorithm is performed based on the power spectrum to obtain an index set B of channel paths, and an index set C of channel paths is determined based on the predefined or preconfigured index set A of channel paths and index set B of channel paths. One or more delay ratio parameters are determined according to the index set C of channel paths and the power spectrum, for example, one or more delay ratio parameters are determined according to one or more predefined or preconfigured thresholds and the power values corresponding to the elements in the index set C of channel paths in the power spectrum. One or more delay are determined according to one or more delay ratio parameters and the index set C of channel paths, local signals for self-interference cancellation are determined according to one or more delays and the foregoing sensing signal, a self-interference channel estimation is performed according to the foregoing local signals and the echo, a reconstructed signal of self-interference is obtained based on the result of self-interference channel estimation and the sensing signal, and a self-interference cancellation is performed on the echo signal according to the echo signal and the reconstructed signal of self-interference to obtain a residual signal.

For example, one possible implementation of performing self-interference cancellation on sum beam and differential beam is to use the corresponding methods related to self-interference cancellation in the above embodiments.

One possible implementation of performing self-interference cancellation on sum beam and differential beam by using the above former embodiment is given below. For example, a first signal is a beam signal, and a first self-interference cancellation may be performed on the first signal based on a first parameter set to obtain a first residual signal. The first parameter set may be pre-defined or pre-configured, or may be calculated based on the first signal. One possible implementation of calculating the first parameter set based on the first signal is to perform channel estimation on the first signal to obtain a power spectrum, and to determine parameters for the first self-interference cancellation based on the power spectrum. For example, the channel paths corresponding to samples above a predetermined threshold in the power spectrum may be determined as parameters for self-interference cancellation, and/or determining parameters for self-interference cancellation based on the power spectrum comprises comparing the power corresponding to each channel path in the power spectrum with a set threshold and determining an order of self-interference cancellation corresponding to a respective channel path based on a result of the comparison. Similarly, for example, a second signal is a differential beam signal, a second parameter set is determined, and based on the second parameter set, a second self-interference cancellation is performed on the second signal to obtain a second residual signal. Wherein one of the methods for determining the second parameter set is to calculate the second parameter set based on the second signal, specifically, to perform channel estimation on the second signal to obtain a power spectrum, and to determine parameters for the second self-interference cancellation based on the power spectrum.

One possible implementation of performing self-interference cancellation on sum beam and differential beam by using the latter embodiment is given below. For example, a first signal is a beam signal, and a first self-interference cancellation may be performed on the first signal based on a first parameter set to obtain a first residual signal. Wherein one possible implementation of performing the first self-interference cancellation on the first signal based on the first parameter set is to obtain a local signal related to a non-sampling time for self-interference cancellation based on the first parameter set and the first signal, estimate a self-interference channel based on the above local signal and the first signal, obtain a first reconstructed signal based on a result of self-interference channel estimation and the above local signal, and obtain the first residual signal based on the first signal and the first reconstructed signal.

One possible implementation of performing self-interference cancellation on sum beam and differential beam by using the above embodiments is given below. For example, a first signal is a beam signal, and a first self-interference cancellation may be performed on the first signal based on a first parameter set to obtain a first residual signal. The first parameter set may be pre-configured, pre-defined or calculated in real time based on the first signal. Wherein one possible implementation of calculating the first parameter set based on the first signal and performing self-interference cancellation on the first signal is to employ the process of self-interference cancellation corresponding to FIG. 22, wherein the first signal corresponds to the echo signal described in FIG. 22. Similarly, for example, a second signal is a sum beam signal, and a second self-interference cancellation may be performed on the second signal based on a second parameter set to obtain a second residual signal. Wherein the second parameter set may be pre-configured, pre-defined or calculated in real time based on at least one of the first signal and the second signal. Wherein one possible implementation of calculating the second parameter set based on the second signal and performing self-interference cancellation on the second signal is to employ the process of self-interference cancellation corresponding to FIG. 22, wherein the second signal corresponds to the echo signal described in FIG. 22.

The illustrative embodiments described above are described herein and are not intended to be limiting. It should be understood that any two or more of the embodiments disclosed herein can be combined in any combination. For example, the methods described in FIG. 16 or FIG. 17 can be combined with the method described in FIG. 19 and used for self-interference cancellation.

It should be noted that, in the self-interference cancellation process described in the present disclosure, the sensing node transmits a sensing signal, and receives for a period of time so as to obtain a received signal, wherein the received signal may contain an echo signal of the aforementioned sensing signal and the noise, and may possibly further contain the signals transmitted by other nodes.

When the sensing node performs self-interference cancellation, the signal that the node is interested in is the echo or a part of the echo. Therefore, a possible self-interference cancellation method supports the node to perform self-interference channel estimation and self-interference cancellation on the same signal.

In a feasible self-interference cancellation process, the sensing node transmits a sensing signal A, and receives for a period of time so as to obtain a received signal B. Based on the sensing signal A, a self-interference channel estimation is performed on the received signal B, and the estimation result is denoted as a self-interference channel C here, wherein the method for self-interference channel estimation may be at least one of the methods proposed above for self-interference channel estimation, for example, a self-interference channel estimation may be performed by using the local signal for self-interference cancellation corresponding to a non-sampling time, calculated by the method described above, or by using the local signal for self-interference cancellation corresponding to a sampling time. The sensing node obtains a reconstructed signal of the self-interference caused by the sensing signal A in the received signal B based on the sensing signal A and the self-interference channel C, or the sensing node obtains a reconstructed signal of the self-interference caused by a certain part of the sensing signal A in the received signal B based on the certain part of the sensing signal A and the self-interference channel C. Next, the sensing node performs self-interference cancellation on the received signal B based on the obtained reconstructed signal of self-interference. The above self-interference cancellation process has the beneficial effects that the parameters related to self-interference cancellation can be dynamically calculated according to the received signal, a more accurate result of self-interference channel estimations can be obtained, and a better effect of self-interference cancellation can be achieved. Meanwhile, the estimation of self-interference channel by using the local signal reconstruction method in the present invention has beneficial effects that the parameters related to the self-interference cancellation of the received signal can be calculated more accurately, a more accurate result of self-interference channel estimation can be obtained, and a better effect of self-interference cancellation can be achieved.

The self-interference cancellation process described in the present disclosure may also be performed by a certain node in a communication system (e.g., a full-duplex system), and accordingly, the signal that the node is interested in may be the signal transmitted by other nodes, rather than the echo or a part of the echo. Therefore, a possible self-interference cancellation method supports the node to perform self-interference channel estimation and self-interference cancellation on different signals.

In a feasible self-interference cancellation process, the sensing node transmits a sensing signal A, and receives for a period of time so as to obtain an echo signal corresponding to the sensing signal A, which is regarded as a received signal B, and a self-interference channel estimation is performed on the received signal B based on the sensing signal A, and a result of the estimation is denoted as a self-interference channel C, wherein the self-interference channel estimation method may be at least one of the self-interference channel estimation methods proposed above. For example, a self-interference channel estimation may be performed by using a local signal for self-interference cancellation corresponding to a non-sampling time, calculated by the method described above, or by using a local signal for self-interference cancellation corresponding to a sampling time. The sensing node transmits a sensing signal E, and receives for a period of time to obtain an echo signal corresponding to the sensing signal E, which is denoted as a received signal D; a local signal for self-interference cancellation corresponding to the non-sampling time is determined based on the sensing signal E; a reconstructed signal of self-interference is obtained based on the sensing signal E and the self-interference channel C, and optionally, a local signal corresponding to a non-sampling time related to the sensing signal E is determined based on the sensing signal E, which is referred to as a local signal F, and the reconstructed signal of self-interference is obtained based on the local signal F and the self-interference channel C, and a self-interference-cancellation is performed on the received signal D. The above self-interference cancellation process has beneficial effects that the computational complexity of the system can be reduced. For example, the nodes may periodically perform estimation on the self-interference channel and use the results of self-interference channel estimation for the self-interference cancellation of the signals received at other times, thus reducing the computational complexity introduced by the self-interference channel estimation. Meanwhile, using the local signal reconstruction method in the present disclosure to perform estimation on the self-interference channel has beneficial effects that: the parameters related to the self-interference cancellation of the received signal can be calculated more accurately, and a more accurate result of self-interference channel estimations can be obtained, and a better effect of self-interference cancellation can be achieved.

According to the embodiments of the present disclosure, there may also provide a computer-readable storage medium storing instructions, wherein when the instructions are executed by at least one processor, the at least one processor is caused to perform any one of the above methods according to exemplary embodiments of the present disclosure. Examples of computer-readable storage media here include: read-only memory (ROM), random-access programmable read-only memory (PROM), electrically erasable programmable read-only memory (EEPROM), random-access memory (RAM), dynamic random-access memory (DRAM), static random-access memory (SRAM), flash memory, nonvolatile memory, CD-ROM, CD-R, CD+R, CD+R, CD-RW, CD+RW, DVD-ROM, DVD-R, DVD+R, DVD-RW, DVD+RW, DVD-RAM, BD-ROM, BD-R, BD-R LTH, BD-RE, Blu-ray or optical disk storage, hard disk drive (HDD), solid state disk (SSD), card-type storage (such as multimedia card, secure digital (SD) card or extreme digital (XD) card), magnetic tape, floppy disk, magneto-optical data storage, optical data storage, a hard disk, a solid state disk, and any other device configured to store a computer program and any associated data, data files and data structures in a non-transitory manner and provide the computer program and any associated data, data files and data structures to a processor or computer so that the processor or computer can execute the computer program. The instructions or computer programs in the above computer-readable storage medium can run in an environment deployed in computer devices such as clients, hosts, proxy devices, servers, etc. In addition, in one example, the computer programs and any associated data, data files and data structures are distributed across networked computer systems, so that the computer programs and any associated data, data files and data structures are stored, accessed and executed in a distributed manner by one or more processors or computers.

Those skilled in the art will understand that the above-described illustrative embodiments are described herein and are not intended to be limiting. It should be understood that any two or more of the embodiments disclosed herein may be combined in any combination. Furthermore, other embodiments may be utilized and other changes may be made without departing from the spirit and scope of the subject matter presented herein. It will be readily appreciated that the various aspects of the disclosed invention, as generally described herein and illustrated in the accompanying drawings, may be arranged, substituted, combined, separated, and designed in various different configurations, all of which are herein was envisaged.

Those of skill in the art will understand that the various illustrative logic blocks, modules, circuits, and steps described herein can be implemented as hardware, software, or combinations of both. To clearly illustrate this interchangeability of hardware and software, various illustrative components, blocks, modules, circuits, and steps have been described above generally in terms of their function sets. Whether such a feature set is implemented as hardware or software depends on the specific application and design constraints imposed on the overall system. Those skilled in the art may implement the described function sets in varying ways for each particular application, but such design decisions should not be interpreted as causing a departure from the scope of the present application.

The various illustrative logic blocks, modules, and circuits described in the present application may be implemented or performed in general-purpose processors, digital signal processors (DSPs), application specific integrated circuits (ASICs), field programmable gate arrays (FPGAs) or other programmable logic devices, discrete gates or transistor logisc, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, such as a combination of a DSP and a microprocessor, multiple microprocessors, one or more microprocessors cooperating with a DSP core, or any other such configuration.

The steps of a method or algorithm described herein may be embodied directly in hardware, in a software module executed by a processor, or in a combination of the two. A software module may reside in RAM memory, flash memory, ROM memory, EPROM memory, EEPROM memory, registers, hard disk, removable disk, or any other form of storage medium known in the art. An exemplary storage medium is coupled to the processor such the processor can read information from, and write information to, the storage medium. In the alternative, the storage medium may be integrated into the processor. The processor and storage medium may reside in the ASIC. The ASIC may reside in the user equipment. In the alternative, the processor and storage medium may reside in the user equipment as discrete components.

In one or more exemplary designs, the functions may be implemented in hardware, software, firmware, or any combination thereof. If implemented in software, the functions may be stored on or transmitted over as one or more instructions or code in a computer-readable medium. Computer-readable media comprises both computer storage media and communication media including any medium that facilitates transfer of a computer program from one place to another. A storage medium can be any available medium that can be accessed by a general purpose or special purpose computer.

Other implementation schemes of the present disclosure will be easily occur to those skilled in the art after considering the specification and practicing the present invention disclosed herein. The present application is intended to cover any variations, uses or adaptations of the present disclosure, which follow the general principles of the present disclosure and include common sense or conventional technical means in the art that are not disclosed in the present disclosure. The specification and embodiments are to be regarded as exemplary only, with the true scope and spirit of the present disclosure being defined by the claims.

What has been described above is only the specific implementation of the present disclosure, but the protection scope of the present disclosure is not limited to this. Any skilled person familiar with the art can make various changes or substitutions within the technical scope disclosed in the present disclosure, and such changes or substitutions should be included in the protection scope of the present disclosure. Therefore, the protection scope of the present disclosure should be based on the protection scope of the claims.

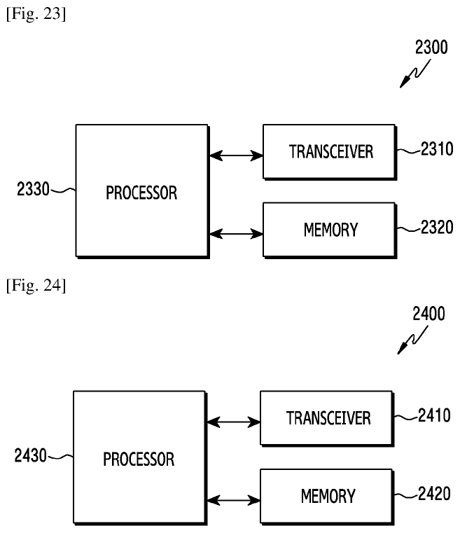

FIG. 23 illustrates a structure of a UE according to an embodiment of the disclosure.

As shown in FIG. 23, the UE according to an embodiment may include a transceiver 2310, a memory 2320, and a processor 2330. The transceiver 2310, the memory 2320, and the processor 2330 of the UE may operate according to a communication method of the UE described above. However, the components of the UE are not limited thereto. For example, the UE may include more or fewer components than those described above. In addition, the processor 2330, the transceiver 2310, and the memory 2320 may be implemented as a single chip. Also, the processor 2330 may include at least one processor. Furthermore, the UE of FIG. 23 corresponds to the UE of FIG. 1 to FIG. 22.

The transceiver 2310 collectively refers to a UE receiver and a UE transmitter, and may transmit/receive a signal to/from a base station or a network entity. The signal transmitted or received to or from the base station or a network entity may include control information and data. The transceiver 2310 may include a RF transmitter for up-converting and amplifying a frequency of a transmitted signal, and a RF receiver for amplifying low-noise and down-converting a frequency of a received signal. However, this is only an example of the transceiver 2310 and components of the transceiver 2310 are not limited to the RF transmitter and the RF receiver.

Also, the transceiver 2310 may receive and output, to the processor 2330, a signal through a wireless channel, and transmit a signal output from the processor 2330 through the wireless channel.

The memory 2320 may store a program and data required for operations of the UE. Also, the memory 2320 may store control information or data included in a signal obtained by the UE. The memory 2320 may be a storage medium, such as read-only memory (ROM), random access memory (RAM), a hard disk, a CD-ROM, and a DVD, or a combination of storage media.

The processor 2330 may control a series of processes such that the UE operates as described above. For example, the transceiver 2310 may receive a data signal including a control signal transmitted by the base station or the network entity, and the processor 2330 may determine a result of receiving the control signal and the data signal transmitted by the base station or the network entity.

FIG. 24 illustrates a structure of a base station according to an embodiment of the disclosure.

As shown in FIG. 24, the base station according to an embodiment may include a transceiver 2410, a memory 2420, and a processor 2430. The transceiver 2410, the memory 2420, and the processor 2430 of the base station may operate according to a communication method of the base station described above. However, the components of the base station are not limited thereto. For example, the base station may include more or fewer components than those described above. In addition, the processor 2430, the transceiver 2410, and the memory 2420 may be implemented as a single chip. Also, the processor 2430 may include at least one processor. Furthermore, the base station of FIG. 24 corresponds to base station of FIG. 1 to FIG. 23.

The transceiver 2410 collectively refers to a base station receiver and a base station transmitter, and may transmit/receive a signal to/from a terminal(UE) or a network entity. The signal transmitted or received to or from the terminal or a network entity may include control information and data. The transceiver 2410 may include a RF transmitter for up-converting and amplifying a frequency of a transmitted signal, and a RF receiver for amplifying low-noise and down-converting a frequency of a received signal. However, this is only an example of the transceiver 2410 and components of the transceiver 2410 are not limited to the RF transmitter and the RF receiver.

Also, the transceiver 2410 may receive and output, to the processor 2430, a signal through a wireless channel, and transmit a signal output from the processor 2430 through the wireless channel.

The memory 2420 may store a program and data required for operations of the base station. Also, the memory 2420 may store control information or data included in a signal obtained by the base station. The memory 2420 may be a storage medium, such as read-only memory (ROM), random access memory (RAM), a hard disk, a CD-ROM, and a DVD, or a combination of storage media.

The processor 2430 may control a series of processes such that the base station operates as described above. For example, the transceiver 2410 may receive a data signal including a control signal transmitted by the terminal, and the processor 2430 may determine a result of receiving the control signal and the data signal transmitted by the terminal.

1. A method performed by a device in a wireless communication system, the method comprising:
identifying a first signal and a second signal, wherein the first signal is associated with a sum beam signal and the second signal is associated with a differential beam signal; and
performing first self-interference cancellation on the first signal based on a first parameter set to obtain a first residual signal associated with a sensing.

2. The method of claim 1, further comprising:
identifying a second parameter set; and
performing second self-interference cancellation on the second signal based on the second parameter set to obtain a second residual signal.

3. The method of claim 2, further comprising:
performing the sensing through the first residual signal and the second residual signal,
wherein the second parameter set is determined based on at least one of the first parameter set, the first signal or the second signal.

4. The method of claim 2, wherein the second parameter set includes at least one of information on an order of the second self-interference cancellation or at least one of channel paths of the second self-interference cancellation.

5. The method of claim 4, further comprising:
identifying the order of the second self-interference cancellation based on an order of the first self-interference cancellation in the first parameter set.

6. The method of claim 1, further comprising:
identifying a third signal;
performing channel estimation on the third signal to obtain a power spectrum;
determining parameters for a third self-interference cancellation based on the power spectrum; and
performing the third self-interference cancellation based on the parameters for the third self-interference.

7. The method of claim 6, wherein the parameters for the third self-interference include at least one of an index of channel path for the third self-interference cancellation, an index set of channel paths for the third self-interference cancellation, an order of the third self-interference cancellation, or an order corresponding to a channel path of the third self-interference cancellation.

8. The method of claim 7, further comprising:
identifying channel paths corresponding to samples in the power spectrum that are above a threshold.

9. A device in a wireless communication system, the device comprising:
a transceiver; and
a controller coupled with the transceiver and configured to:
identify a first signal and a second signal, wherein the first signal is associated with a sum beam signal and the second signal is associated with a differential beam signal, and
perform first self-interference cancellation on the first signal based on a first parameter set to obtain a first residual signal associated with a sensing.

10. The device of claim 9, wherein the controller is further configured to:
identify a second parameter set, and
perform second self-interference cancellation on the second signal based on the second parameter set to obtain a second residual signal.

11. The device of claim 10, wherein the controller is further configured to:
perform the sensing through the first residual signal and the second residual signal,
wherein the second parameter set is determined based on at least one of the first parameter set, the first signal or the second signal.

12. The device of claim 10, wherein the second parameter set includes at least one of information on an order of the second self-interference cancellation or at least one of channel paths of the second self-interference cancellation.

13. The device of claim 12, wherein the controller is further configured to:
identifying the order of the second self-interference cancellation based on an order of the first self-interference cancellation in the first parameter set.

14. The device of claim 9, wherein the controller is further configured to:
identify a third signal,
perform channel estimation on the third signal to obtain a power spectrum,
determine parameters for a third self-interference cancellation based on the power spectrum, and
perform the third self-interference cancellation based on the parameters for the third self-interference.

15. The device of claim 14, wherein the parameters for the third self-interference include at least one of an index of channel path for the third self-interference cancellation, an index set of channel paths for the third self-interference cancellation, an order of the third self-interference cancellation, or an order corresponding to a channel path of the third self-interference cancellation.
